(19) United States
(12) Patent Application Publication
(10) Pub. No.: US 2022/0270002 A1
(43) Pub. Date: Aug. 25, 2022

(54) Value Systems

(71) Applicant: Shawn R. Hutchinson, Harpers Ferry, WV (US)

(72) Inventor: Shawn R. Hutchinson, Harpers Ferry, WV (US)

(21) Appl. No.: 17/705,045

(22) Filed: Mar. 25, 2022

Related U.S. Application Data
(63) Continuation-in-part of application No. 17/684,067, filed on Mar. 1, 2022.
Application No. 17/684,067 is a continuation of application No. 16/634,403, filed on Jan. 27, 2020.
(60) Provisional application No. 62/537,796, filed on Jul. 27, 2017.

(51) Int. Cl. G06Q 10/02; G06F 16/9535; G06Q 20/04; G06Q 10/10; G06Q 20/02; G06Q 30/06

(52) U.S. Cl. CPC G06Q 10/02; G06F 16/9535; G06Q 20/047; G06Q 10/1095; G06Q 20/023; G06Q 30/0633

(57) ABSTRACT

Attributes used to address and produce value.

### CROSS-REFERENCE TO RELATED APPLICATIONS

This application is a continuation-in-part of U.S. application. Ser. No. 17/684,067, filed Mar. 1, 2022, which is a continuation of U.S. application Ser. No. 16/634,403, filed Jan. 27, 2020, which is a National Phase of PCT International Application No. PCT/US2018/044,189 filed Jul. 27, 2018, which claims the benefit of U.S. Provisional Patent Application No. 62/537,796, filed Jul. 27, 2017 entitled “Value Systems”, the entire contents of these application are incorporated by reference.

This application is a continuation-in-part of U.S. application Ser. No. 16/467,775, filed Jun. 7, 2019, which is a National Phase of PCT International Application No. PCT/US2017/065,313, filed Dec. 8, 2017, which claims the benefit of U.S. Provisional Patent Application No. 62/432,528, filed Dec. 9, 2016, entitled “A Unique Pricing Engine”, the entire contents of these application are incorporated by reference.

This application is a continuation-in-part of U.S. application. Ser. No. 16/481,778, filed Jul. 29, 2019, which is a National Phase of PCT International Application No. PCT/US2018/015,401, filed Jan. 26, 2018, which claims the benefit of U.S. Provisional Patent Application No. 62/451,520, filed. Jan. 27, 2017 entitled “Secure Authentication and Financial Attributes Services”, the entire contents of these application are incorporated by reference.

This application is a continuation-in-part of U.S. application Ser. No. 17/281,906, filed Mar. 31, 2021, which is a National Phase of PCT International Application No. PCT/US2019/046,901 filed Aug. 16, 2019, which claims the benefit of U.S. Provisional Patent Application No. 62/719,992, filed Aug. 20, 2018, entitled “Scheduling, Booking, and Pricing Engines'”, the entire contents of these application are incorporated by reference.

### FIELD OF INTEREST

Value Systems seek to relate logic, reason, affect, value, and interpretation in ways that are numerically relevant. Numerical relevance in this sense encompasses, for example, monetary values as well as numerical representation of quantifiable relations and inequalities such as, for example, spaces, coordinates, values, evaluations, comparison purposes, and their representations in bits and qubits. Values, however, refers to the value in terms of a quantifiable relation as well as to the value in terms of sensible relations or qualifiable relations. Value Systems furthermore expresses either in quantifiable and/or qualifiable terms the relations among terms of logic, reason, affect, value, and interpretation.

### STATE OF THE ART

Existing measures to related logic and reason to value are often ascribed to formal systems and to some extent probabilistic models. First order and second order relations of cause, effect, and their associations are conventionally implemented to determine roles and relations among reason and their values. And while historically the sense of the terms ‘springs of action’ and ‘human motivation’ are retained in reasoned and emotive domains, the complexity of human action appertains to additional terms that may be obfuscated from the analyses in terms of formalities and probabilities. The analyses that approach deterministic systems among them are furthermore limited by the terms used to account articulate, characterize, describe, and explain. And so, philosophical and numerical procedures that are implemented to determine them are hindered by the terms and concepts used to convey the logic, meaning, and value of affect and reason as well as interpretations there-among and there-between.

Another way to refer to existing conundrums that vex attempts to relate human action to purely deterministic probabilities and materialistic formalities, for example, are to point to the analytical systems used to explain them. For example, formal systems are often relying on the structures of thought that are implemented in order to articulate them. Namely, one the one hand, are hierarchical structures such as the measured analytics, metrical comparisons, Linnaean classification, whole-part, and metaphysical relationships. And on the other, discursive and dispositive procedures for relating truth, emotion, feeling, meaning, value, and through communicative and expressive relationships. The procedures rely on forms of logic and justification that are indeterminate and insensitive with regards to parameters that are undisclosed according to the terms of their relational system.

Moreover, formal systems are often limited to what is known by them, and discovering what is not known is rather problematic for systems that rely on rote formalities and probabilities to describe and relate systems of human logic, reason, affect, and value. An intelligent human observer who does not know that s/he is color blind is unaware that they cannot observe the color red or the color green, as the case may be. Such a person requires another device to filter red or green color in order to see a tinted contrast and to recognize a difference in two colors that is otherwise readily visible to an unassisted intelligent observer. To the observer who cannot see red or green, the names for colors used to describe the colors that the person sees probably does reflect what s/he is able to see but does not describe the factual reality of a normal view that is otherwise imperceptible to her/him without a visual assistance device. A person therefore does not know the specific terms that s/he does not know.

While procedures for referring to formalistic and probabilistic systems are able to, in a limited extent, refer generally to things that are not known, the purpose of Value Systems is to define ways for ascertaining the specifics of things that are unknown and unknowable without another device. Some existing ways that generally such things are referred to are in terms of fuzzy logic, membership functions, game theory, chicken-and-egg, prisoner dilemma, traveling salesman, etc. Other ways may refer to constrain-unconstrained, completeness-incompleteness, certainty-uncertainty, and other kinds of dichotomies that do their best to account for observations about complex systems. Further ways to point to the properties of systems in one way or another with reference to so-called ‘hidden variables’ or to deep systems as subordinate experience, ego, libido, subconsciousness, etc. Value Systems is thus directed towards explicating comprehensively complex systems.

We are interested here in providing the computational structure that allows for complex terms that govern relations among logic, reason, affect, value, and interpretation to be explicated in quantifiable and qualifiable ways. Quantifiable ways may be numbers, colors, prices, data, and structures. Qualifiable ways may be affective, emotive, sense, sensibility, and feeling. Interpretation therefore appertains to the determinacy among and between terms that are at least to a partial extent quantifiable and at least to a partial extent qualifiable. Generally speaking human and artificial systems encompass such relations. Interpretation relates to the ways that the qualifiable and quantifiable are expressed and represented through relations among them. The purpose of Value Systems is to determine and discover the ways that these terms are related. Interpretation therefore relates to means of relating the meaning of one communicative system to another, and therefore further encompasses for example expression, translation, transcribing, converting, and exchanging.

### SUMMARY

Value Systems determines ways of quantifying as well as interpreting among and between quantifiable and qualifiable attributes, properties, and states. One of the most useful examples of doing so—to interpret from logic and reason to affect and value, and vice versa—is to implement systems that numerical ascribe states to each. The present invention is directed towards clarifying systems that are ambiguous, fuzzy, undescribed, indeterminate, and/or partially comprehended. Another way of setting forth the use of value system is an interpretive adapter among and between logical systems, such as essentialism-existentialism, reason-experience, and absolutism-perspectivalism. The systems herein contain a set of useful sources in accomplishing the procedures required to obtain these results, as well as detailed disclosure of a system that is useful in producing such results in terms of monetary values. The aim of Value Systems is in other words, at least in part, and goal is to resolve the unknown.

Statistical, probabilistic, inferential, interpolative, and extrapolative processes may be useful in determining associations and correlations among and between data points including, for example, causation, steps, translations, sets, and sequencing in terms of time as well as cause-effect. Examples and embodiments contained herein shall not be construed as a limitation, either implicit or explicit.

### LIST OF FIGURES

FIGS. 1A-1C. Data Sets.

FIGS. 2A-2B. Set Price in Amount Per Participant

FIGS. 3A-3B. Member Index Initialize Value.

FIGS. 4A-4B. Aggregate Rules for Donations.

FIG. 5. Resource Buffers.

FIGS. 6A-6B. Basic Data and Advanced Data.

FIGS. 7A-7B. Your Price Displays.

FIGS. 8A-8D. Verify Financial Data.

FIG. 9A-9B. Ethnics Table and Denominations Table.

FIG. 10. Member Sample Data.

FIG. 11. State Sales Taxes.

FIG. 12. Attribute Addresses.

FIG. 14. Member Account and Provider Account Profiles.

FIG. 15. Websites and Webpages.

FIG. 16. Search Flow.

FIG. 17. Schedule Flow With Pricing Engine.

FIG. 18. Pricing Engine Data Attributes.

FIG. 19. Payment Assembler Rover Flowchart.

FIG. 20. Assembler Payment.

FIG. 21. Donations Flow.

FIG. 22. Booking Option Pull Assembler Flowchart.

FIGS. 23A-23C. Account and Profile.

FIG. 24. Search Interface.

FIGS. 25A-25D. An Application Procedure Workflow.

### EMBODIMENTS

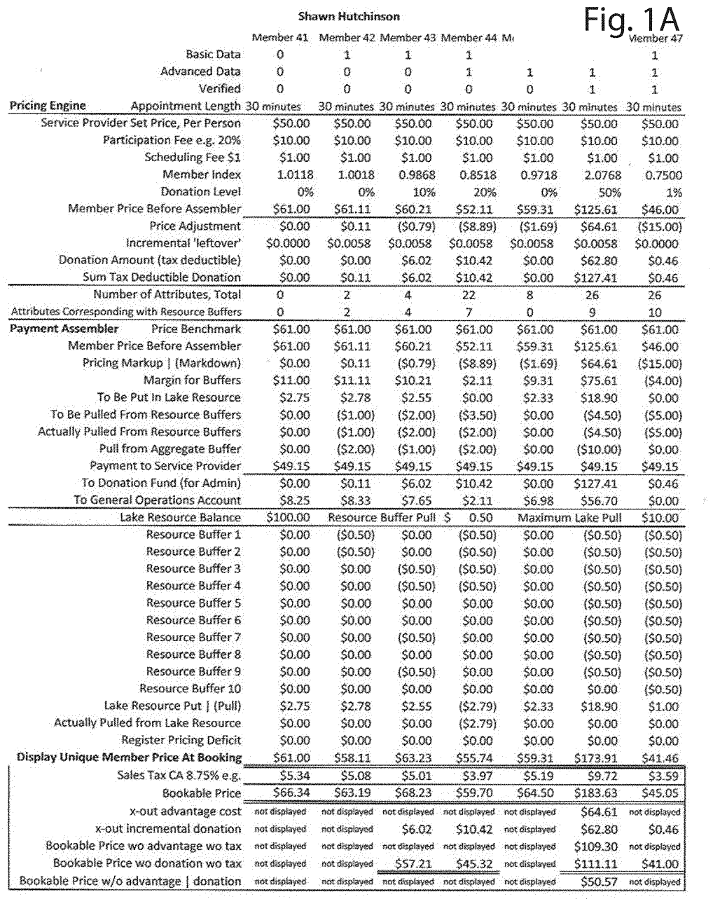

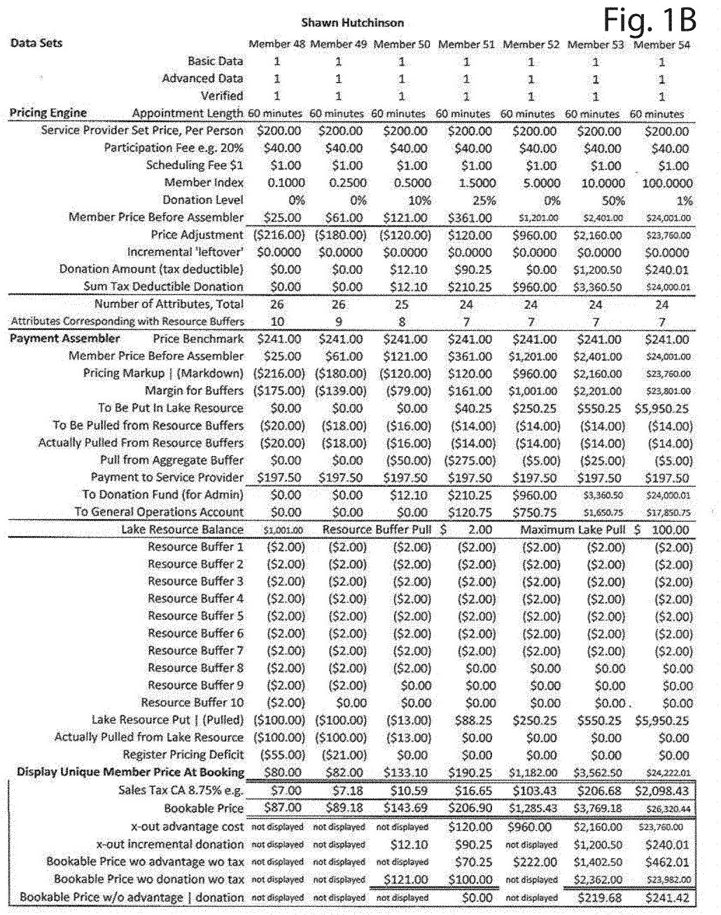

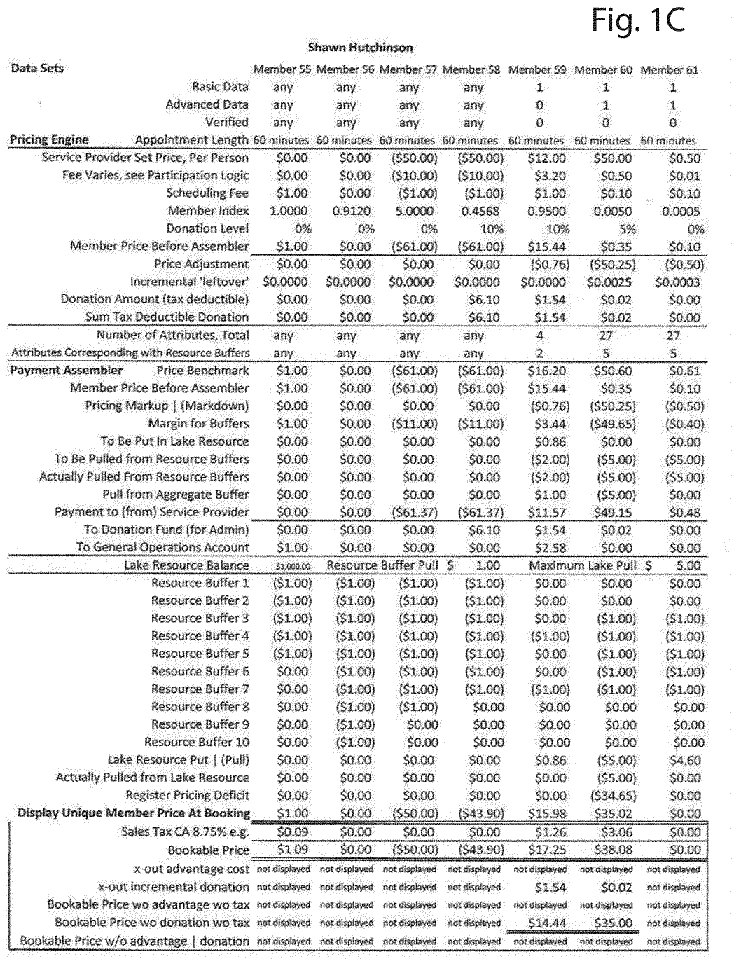

FIGS. 1A-1C. Data Sets show the relation among prices according to personal attributes that are interpreted through Resource Buffers. A representation of a digest. Prices are displayed according to these, as well as selections that a person (member) makes in terms of the amounts they wish to donate as well as in terms of the prices that they are shown according to the Member Index.

The Pricing Engine, 100, may use attribute data about a consumer, seller, entity, or combinations thereof. This can include basic data, advanced data, and verified data. The basic data can include, for example, general attribute data, demographic, or location data. Advanced data can include, for example, specific attribute data about a person, personal identifying attributes, sector attributes, and financials. Verified data is authenticated by a person or entity that is stored or confirmed at a time of request.

The Set Price for a product or service is a price set by a consumer, person, seller, or entity. This can be a price that is tendered for a buyer, in that it is a price that a person may purchase a product or service. A Participation Fee may include a subscription or membership for unique, addressable, or attribute pricing. This can be, e.g., a volume discount, derivative, or fee for use. A fee may be charged to a person, seller, or entity for usage of the system.

The Member Index is used to ascribe a quantified index that compares a measure with a statistical base. For example, the index may be used to determine socioeconomic status compared with other consumers. A consumer index may be used to determine that the economic means of a person is higher or lower than an average, mean, median, normalized amount, any statistical indicator, mathematical marker, and the like. The member index can be used to adjust or produce a unique price for a consumer, based on some mathematical, quantitative, or even a qualitative difference between a Set Price and the payable or paid price for a product or service. The index may be used to compensate for a quantitative or qualitative difference between persons, aggregates, analytics, entities, and the like. A qualitative difference can be based on affective attributes, feeling, belief, emoji, sensory input, and the like. The system can produce a unique price with or without a price subsidy, rebate, discount, coupon, or any offset difference between the Set Price and the paid price. The index may be used to produce a second price using a mathematical operation, comparison, or affective attribute.

A Donation may be made at or before the time of purchase by including an amount into the unique price. The donation amount can be in a percentage form from zero to any maximum value set, at or above 100%. The donation amount can be in a monetary form, value, credit, barter, exchange, reward, and the like for goods or services.

The Number of Attributes can range from 0 to a number, as one or more integer, fractional, positive, real, negative, rational, irrational, imaginary, and the like, according to a model used to determine obtaining or allocation of value, resources, or amounts to or from Resources Buffers, as discussed below. The number of attributes associated with a person, group, or entity may be the same or different from the number used to obtain or allocate values. These correspondences can be pre-set in the Pricing Engine, ad hoc rules, or criteria set by an Administrator, algorithm, policy, program, bot, formula, and the like.

The Price Adjustment is the difference in a monetary value between the Set Price and a purchase price. This adjustment can be caused to notify a person or entity to receive authentication, consent, or validation. It can be accounted for through incentives, promotions, rewards, obligation, exchange, a secondary market, derivative, and the like. Incremental Leftover is the fractional amount of difference less than one-cent. Donation Amount can be a difference, all or portion, of the Price Adjustment that can be accounted for with a tax-deductible donation, reward, credit, non-monetary compensation, and the like. A Donation Amount can be a pre-set amount based on the donation level or determined independent of the donation level.

Payment Assembler, 200, determines a benchmark for a price using the Set Price, taxes, service charges, and fees that are associated with a good or service. The Member Price Before Assembler is determined in the Pricing Engine, 100, and is a purchasable price for a good or service. The Pricing Markup, or Markdown, is a potential adjustment of a purchasable price up or down. The engine may adjust the price down according to the Member Index, for example. Or the consumer or entity may adjust the price up according to the Member Index, Donation Level, or Donation Amount. These adjustments can be made before, during, or after the purchase of a product. A price may be adjusted up in order to add a surcharge to purchase of goods or services that can be distributed to other persons or entities through usage of the value system. Prices can be adjusted according to incentives, distribution, or disincentives.

Margin for Buffers is a difference between the Member Price Before Assembler and the Set Price. This is the amount marked for coverage, compensation, offset, subsidy, and the like. The amount of the Margin may be obtained from one or more accounts, resources, buffers, sources, third parties, derivatives, exchanges, and the like. The Margin can be a positive or negative number, depending on whether resources are to be obtained to offset a reduction in price or an increase in the price for use of the surplus funds for another person, entity, group, account, purpose, and the like.

The To Be Put In Lake Resources are surplus funds from a Margin may be put into one or more resources or accounts for use in the reduction of prices. They may also be used for a future purchase by the same or different consumer or entity. The To Be Pulled From Resource Buffers is a potential amount that the Pricing Engine may seek to obtain from another source to reduce the price for a purchase. The Actually Pulled from Resource Buffer is the actual amount obtained from a Resource Buffer, depending on the availability of resources or funds at any given time. Other types of resource, buffer, subsidy, or surplus account may be connected that have their own sets of rules based on when, how, and whom resources can be used by the Pricing Engine. These rules may be preset in the Pricing Engine or determined in a dynamic way according to usage characteristics, changed settings, machine learning, set by another person, entity, group, and the like.

Payment to Service Provider is the amount of money to be paid to the seller or service provider after a purchase is made. The Pricing Engine may be used to adjust the prices paid to a person, group, or entity, while the price paid to the seller or service provider is the same, regardless of the price paid for the product or service. The payment to the service provider can be further adjusted through a similar operation of the Pricing Engine, through discounts, fees, costs, subsidies, rebates, rewards, and the like.

The surplus proceeds from a purchase or sale can be sent to one or more accounts that are internal or external to the Pricing Engine. The allocation of these proceeds may occur according to rules pre-set in the Pricing Engine, ad hoc rules, or criteria set by an Administrator, policy, formula, and the like.

Lake Buffer Resource, 300, sets the amount of a Pull that can be made to compensate for the Margin between the Set Price and the purchase price. These buffer resources can be one or more, to any maximum number, which can correspond with a monetary account, quantifiable, or qualitative marker that corresponds with a compensation for the Margin, which may be the same, lower, or higher than the Margin amount. Partial Pulls from the buffer can be determined by rules set within the Pricing Engine, before or after the purchase, internal or external to the Pricing Engine. Rules can be set for the minimum, maximum, statistical, patterned, sequenced, programmatic, and like usage of resources buffers that may correspond with the Member Index, data, or rules that are used to distinguish a person, group, entity, product, or service from peers in an ascribed set.

Similarly, a Pull can be a Put, whereby a value is allocated to a resources buffer, as in a Put, which is in contrast to a Pull, where a value is obtained from a resource buffer. Then, the amount pulled or put into one or more resource buffers is determined, which may be a zero, a negative amount, or positive amount. A Put is indicated using a positive number, for example, and a negative number is indicated with parentheses on a number. The amount of value, funds, or resources obtained in a process step, which may be one or more steps, done in sequence, combination, recursion, process, iteration, or selective operation. The amounts obtained can be in combination of one or more sets of steps. The Register Pricing Deficit accounts for the actual amounts obtained that are compared with the Set Price, Price Benchmark, Margin for Buffers, or usage of the steps to compensate for the margin. In other words, if there is a difference in the amount obtained and the amount attempted to be obtained, that difference is recorded. It can be a deficit, surplus, or null number.

The Display Unique Member Price At Booking is a tendered price for the purchaser. The Price may be different or the same for another member or members. This price can be displayed for purchase, at purchase, after purchase, or within the timeline from one or more raw material, intermediary, to delivered goods or service and beyond into financing, credit, purchase vouchers, derivatives, recording, analytics, reports, and the like, and combinations thereof. Sales tax may be added to the Unique Price. A price may be Bookable based on the Unique Price and amount of sales tax, fee, or charge added to the Unique Price, before or after the Pricing Engine steps. The purchaser can selectively remove discounts, surpluses, rebates, rewards, donations, credits, and debits, and the like from the purchase.

An x-out can be used to cross-out one of these adjustments. They can be added or removed to purchase. These can be removed before, during, or after a purchase. Removing an adjustment can cause the purchasable price to go down, if, for example, the donation is removed. Removing an adjustment can cause the purchasable price to go up, if, for example, a donation is readded. Removing adjustments can be performed for donations, discounts, incentives, rebates, rewards, surpluses, and the like. A price may be displayed to one or more persons, groups, entities, programs, reports, and the like or to one or more persons, groups, entities, programs, reports, and the like, wherein the first group is different than the second group. The difference can be categorical, quantitative, qualitative, numerical, incongruence, based on one or more attributes, and the like.

FIG. 1A shows a basic example of the Pricing Engine. FIGS. 1B and 1C show pricing valences or spreads according to different Member Indexes, Donations, and availability of resources. Corresponding descriptions pertain to 100B, 200B, 300B, and 400B. Corresponding descriptions pertain to 100C, 200C, 300C, and 400C.

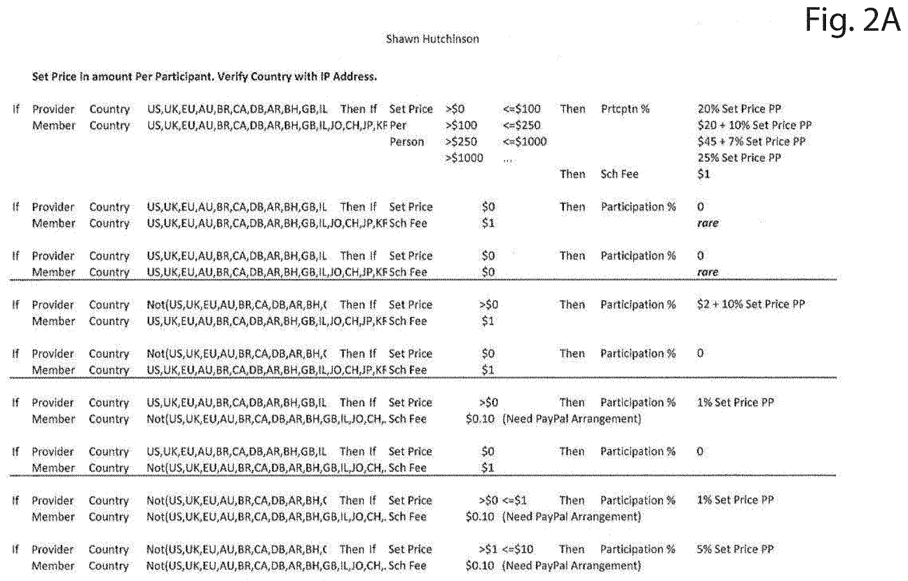

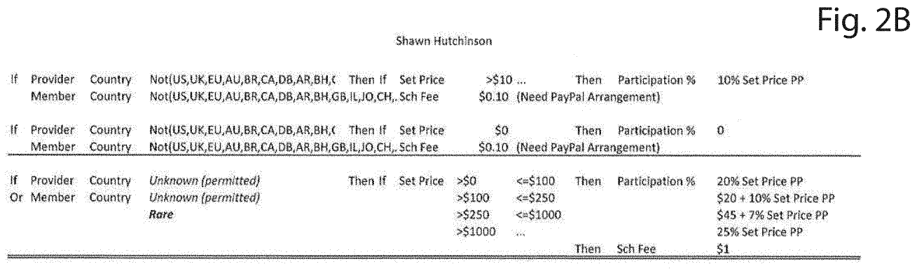

FIGS. 2A-2B. Set Price in Amount Per Participant shows the way that parts of the price are determined according to the participation rate. Participation rate follows logic according to the country that a Provider comes from as well as the country that a Member comes from.

The Member, 2.100, may be a customer, person, group, entity, bot, program, and the like. The Provider, 2.200, may be a seller, retailer, merchant, manufacturer, entity, and the like. A Member can be a Provider and a Provider can be a Member. Participation percentages and fees, 2.300, may be used to account for differences in socioeconomic indexes of the Member and Provider. Other indexes can be used that account for attributes in individual, specific, general, aggregate, statistical, and like ways. Participation relations between Member and Provider are used in the Pricing Engine as a basis of rule making, 2.400. Attributes of the Member or Provider may need to be verified to qualify them for having applicable rules that may be used to determine the provision of pricing, rates, data, content, and other media such as advertising, streaming, and access. Location attributes can be used to define participation, rules, provisions, and the like, 2.500.

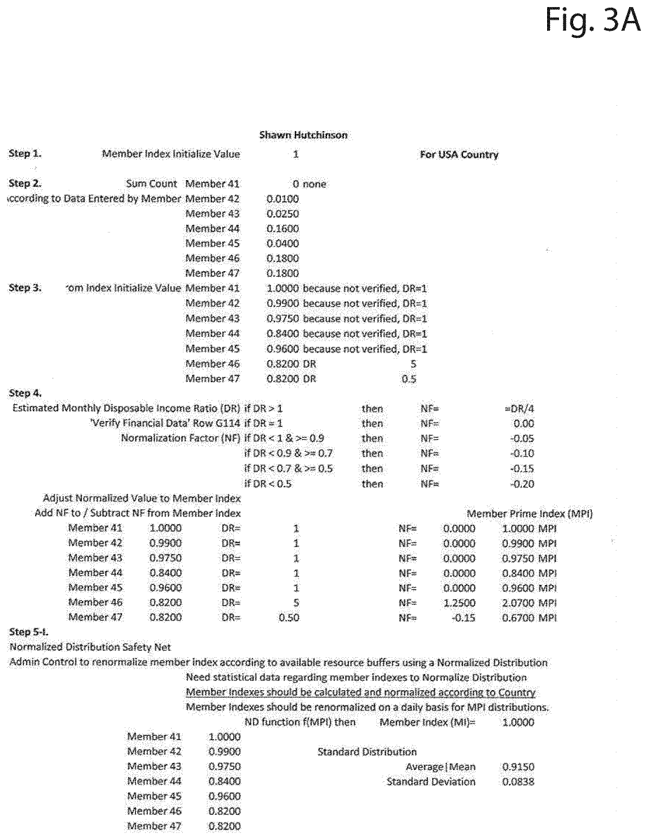

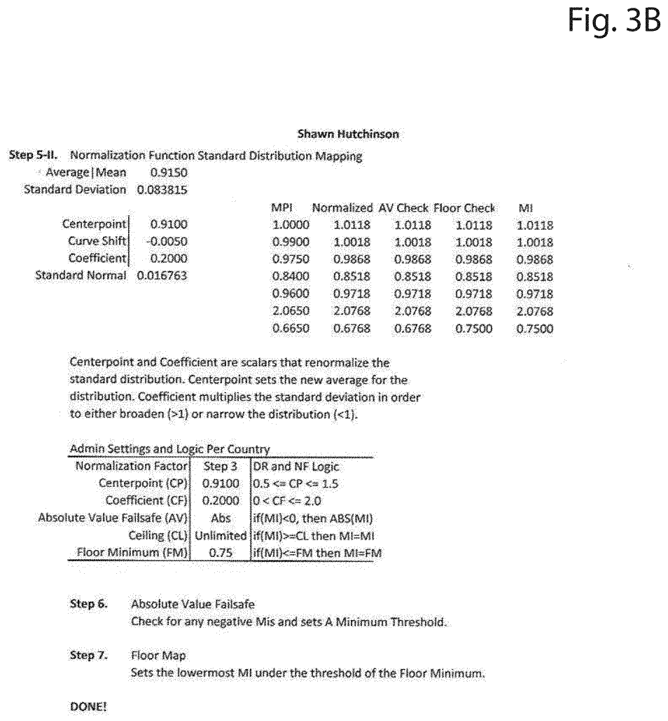

FIGS. 3A-3B. Member Index Initialize Value. Member Indexes are determined according to Verified Income Data that corresponds with a Member's financial data.

The Member Index is determined according to aggregate values in a group. Individual Member Indexes are calculated and then the Members in the group have their indexes normalized. An index value is first calculated using attributes, 3.100. These attributes may have a score that is determined by the value of one or more attributes, the number of attributes, the weight, impact, the like, and combinations thereof. These attributes may be verified in order to substantiate the value or qualify the Member for having the attribute counted towards the score, 3.200. The Index can be mapped to one or more income ratios, socioeconomic means, economic indicators, financial, prime, prime rate, and like attributes, and combinations thereof. If the disposable income ratio (DR) is higher than a mean average, then the Index may be greater than 1, meaning the pricing for the member may be greater than the set price, based on affordability, 3.300. If the disposable income ratio (DR) is lower than unity, then the pricing for the member may be lower than the set price. The value of the impact of DR, the normalization factor (NF), is determined by rules, programs, procedures, policies, and like determinants, 3.400. The indexes can be determined through mathematical, programmatic, machine learning, algorithmic, statistical, and software implemented means, 3.500.

One example is an additive calculation of the indexes, starting first with values of attributes. Then the results of disposable income ratios, the NFs, are added to or subtracted from the index. These modified indexes are then normalized using a statistical process to narrow, spread, or shift the distribution of the scores, 3.600. This is useful to provide resources to the pricing engine according to their availability. Scarcer resources might require a more narrow distribution while abundant resources might have a wider distribution, 3.700. Various statistical and mathematical models may be used to normalize the indexes. Normalization can include average, mean, median, standard deviation, centerpoint, coefficients, minimum (floor), maximum (ceiling), absolute value, thresholds, and the like. Any type of statistical modeling, normalizations, or distribution functions may be used to map indexes to Members or Providers. A Provider Index can be calculated in like manner to determine indexes that are used to calculate the prices paid to a Provider for a good or service. This can be used to adjust payments according to socioeconomic factors, policy, indicators, and the like, for the public good, for example. They may be used to aggregate or correlate attributes of various categories and types, for the purpose of addressing funds to Members or Providers according to socioeconomic, climate, civil, policy, and the like.

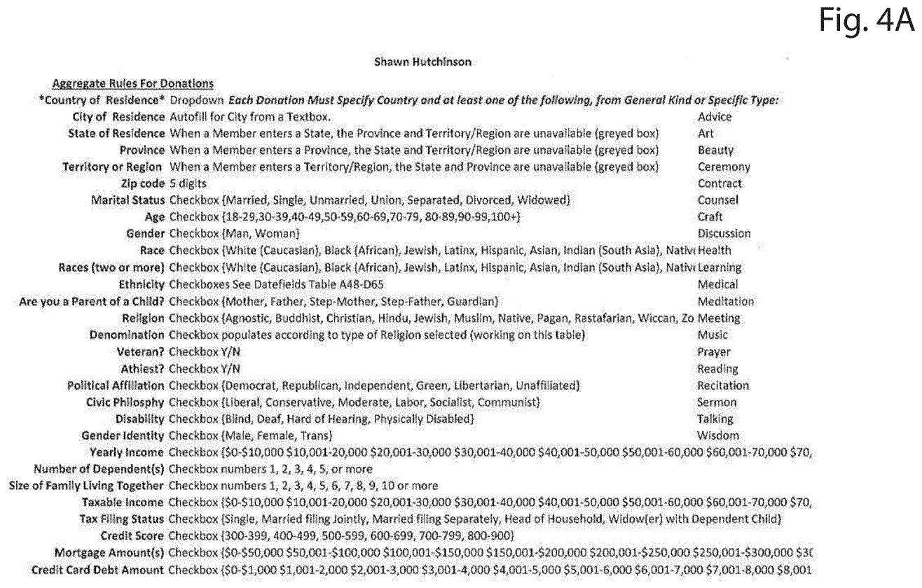

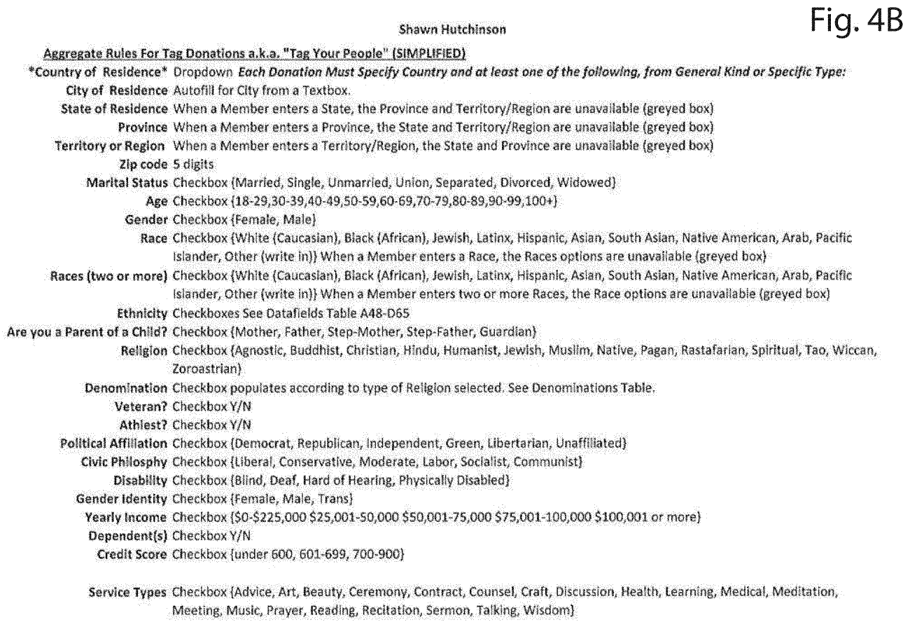

FIGS. 4A-4B. Aggregate Rules for Donations. Logical Rules and options are provided for a person to make a financial contribution that is selected to be presented to the Member at the time of booking.

Attributes related to a person and personal identifying information are listed. These attributes can be used in determining indexes for the purpose of determining pricing. Attribute categories can be, for example, a genus, 4.100, and species, 4.200. Attribute categories can be, for example, a genus, 4.100A, and species, 4.200B. Attribute categories can refer to one or more of a person, product, service, material, process, indicator, code, and the like. These attributes can be used in determining addresses for transmitting data to Members or Providers anonymously. These attributes can be used in transmitting data to Members or Providers. Data can include pricing, content, advertising, incentives, rewards, sound, video, programs, and the like. They may be combined with one or more types of addresses, booking, code, data, device, display, domain, card, cookie, beacon, pixel, protocol, record, register, session, streaming, tier, transmission, website, and the like, and combinations thereof.

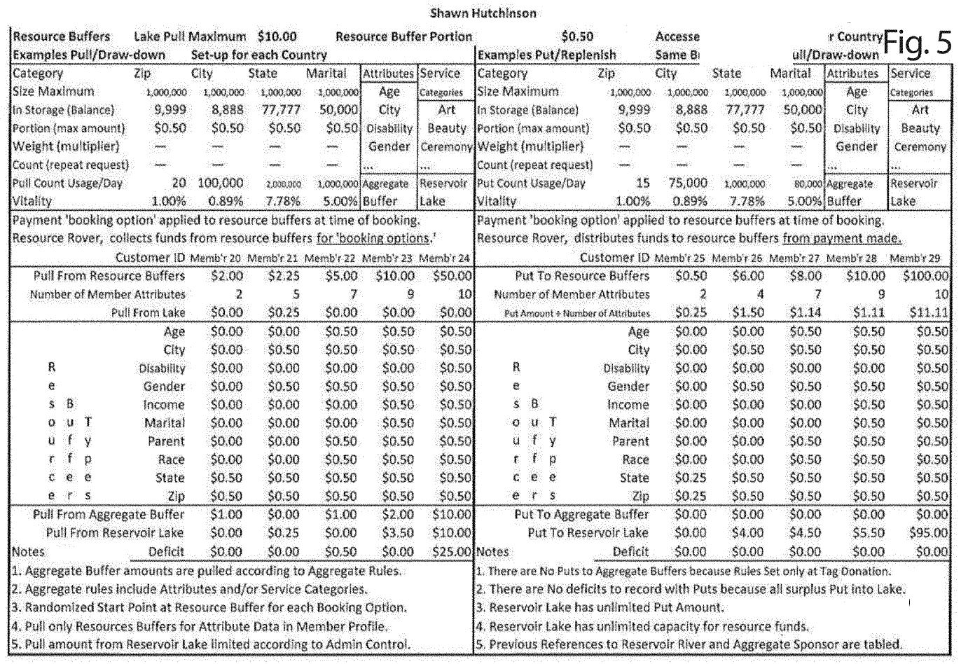

FIG. 5. Resource Buffers. Programmatic Rules and functional properties for the determination of Resource Buffers, prices, and resource allocation.

Specific settings for a pricing engine are shown, from an aggregate birds-eye view and specific uses on a member-basis. One example is given as a Pull option, 5.100, and another as a Put option, 5.200. Pull option can correspond with a Member Index less than one and a Put is greater than one. A pull can remove, retrieve, gather, draw-down, reserve resources, and the like. A put can place, replenish, distribute resources, and the like. Some of the attribute types are frequently used as indicated by the Size Maximum, balance, portion, weight, count, usage, volatility, and the like, 5.110 and 5.210. Others may be used according to desired frequency, depending on potential qualifying Members, availability of resources, and the like, 5.120 and 5.220.

Attributes are used to provide resource credits, 5.130 and 5.230. Rules can be programmed to determine the amount of resources used based on the attribute. As one potential embodiment, attributes can include age, city, disability status, gender, income, marital status, parental status, state, zip, and the like, 5.140 and 5.240. Any attribute can be used with a resource. These can be stored in accounts, resource buffers, and the like, 5.150 and 5.250. Sample accounts for providing resources are linked to attributes. Attributes may be general, like city, state, marital status, and the like. Values for the attribute can be assigned in order to adjust an aggregate value for a customer. One example is using price credits to adjust a price according to socioeconomic means of the recipient. Rules may be used to determine pull and put processes, actions, and the like, 5.160 and 5.260. These can include rules one or more for accounting, distribution, allocation, retrieval, permissions, verification, authentication, and the like, and combinations thereof.

Statistics can be kept about the usage of the resource accounts, or buffers, according to balances, weights, counts, rates, vitality, and the like. These are useful to determine rules, gathering feedback, and optimizing the use of resources for dynamic distribution models. Algorithms, protocols, procedures, policies, and the like may be used to dynamically allocate resources based on demand and supply factors. Algorithms, protocols, procedures, policies, users and the like may be used to define rules at any time, before, during, after usage, and combinations thereof. The factors for determining allocation may be determined according to business, socioeconomic, government, entities, and the like. The allocation factors may be determined based on attribute values and models so that the amounts pulled or put from resource buffers are used to provision unique prices. The attributes may also be used in combination with prices to provide data. Data can include pricing, content, advertising, incentives, rewards, sound, video, programs, and the like.

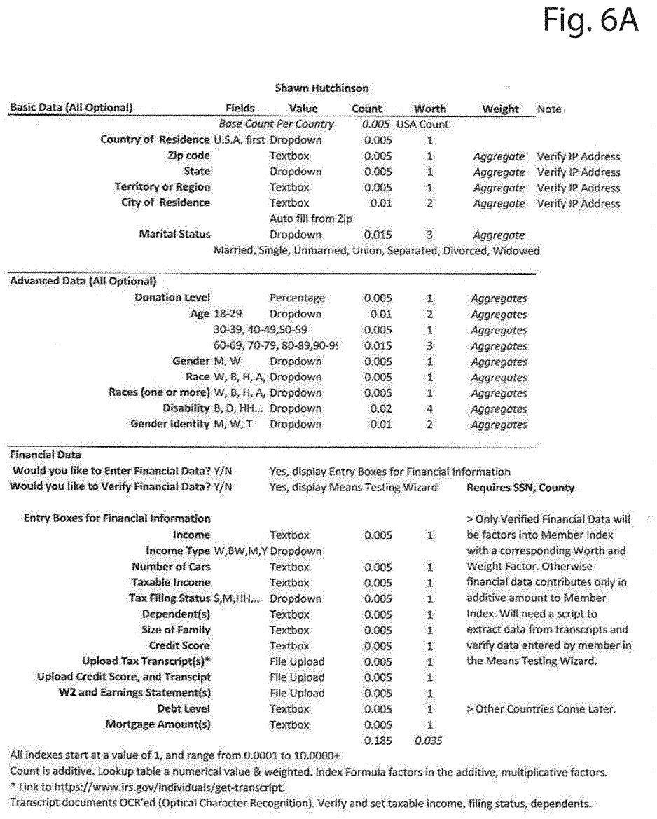

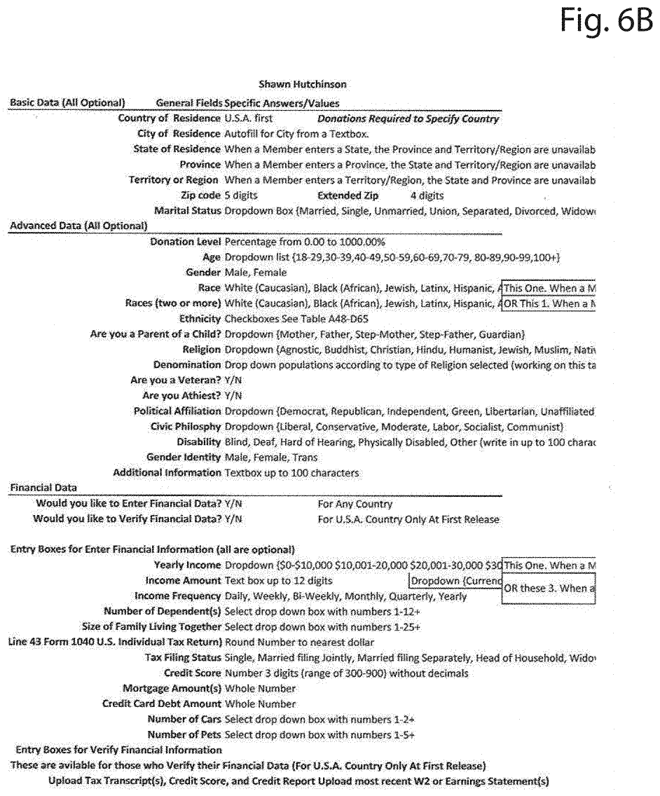

FIGS. 6A-6B. Basic Data and Advanced Data. The weight given to personal data that the Member provides. The tabulations of counts according to worth are used in determining a raw index weight before the member index is further adjusted according to the results of the Verify Financial Information process. The personal attributes that a Member selects from among. The response to the fields are used in determining the Member Index as discussed herein. Counts, weights, and scores can be in a monetary form, value, credit, barter, exchange, reward, and the like for goods or services.

Three types of data are provided, Basic, Advanced, and Financial. Each represents a genus of its own species attribute data. Basic data may include City, State, ZIP code, country, and marital status, for example, 6.100 and 6.100B. Advanced data may include donation level, age, gender, disability, affiliations, affects, beliefs, identity, and the like, 6.200 and 6.200B. Any attribute can be used with a data. Financial Data may include income, number of dependents, tax filing status, number of dependents, size of family, credit score, number of cars, size of family, tax filing status, credit score, mortgage amount, credit card debt, debt amount, number of pets, and the like, 6.300 and 6.300B. Any attribute can be used with a data. Each of these are a genus of their own species. Atlanta, Boston, and Fairfax are species of the City genus. Georgia, Massachusetts, and Virginia are species of State, and so forth. The selection of attribute data species within genuses or categories can be made according to differentiation among one or more identifiers. The types of data may be related or unrelated. They may have one or more shared attributes or have zero shared attributes.

Each species attribute has a count and weight determined as to the value they contribute to a member index. The count is a raw score and the weight is a coefficient used to scale the value. The value of the attribute can be used to calculate the Member index or Provider index, as described in FIGS. 1, 3, and 5, for example. These values are determined based on rules. Rules can be set using statistical, patterned, sequenced, programmatic, and like means. Rules may be based on socioeconomic, climate, civil, policy, and the like. Attributes may be verified in order to validate that a Member or Provider qualifies for the attribute contribution to a pricing index for them.

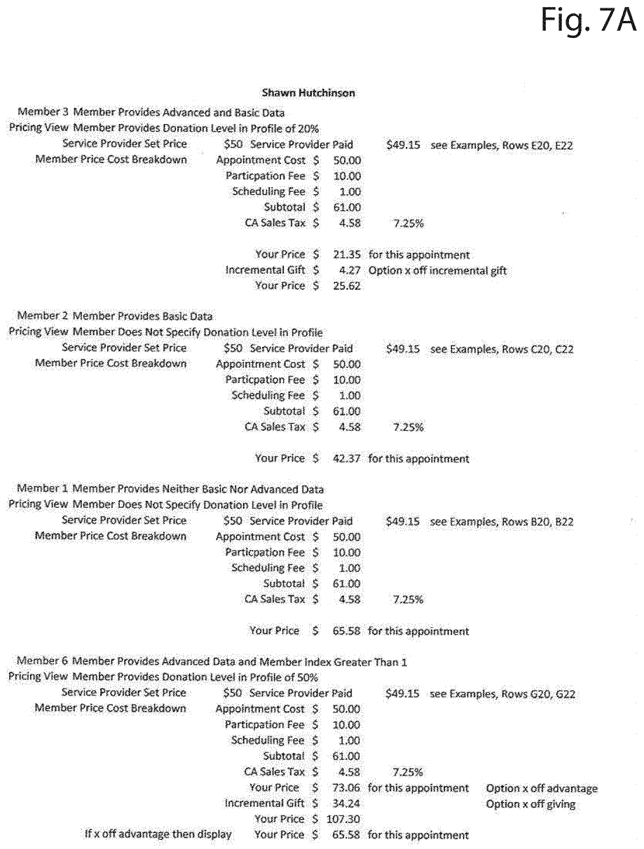

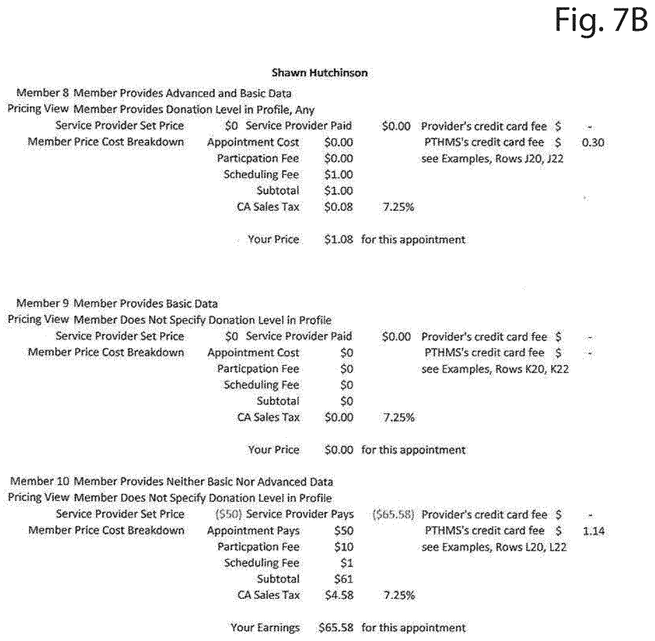

FIGS. 7A-7B. Your Price Displays. Various combinations of price displays for the Member according to the financial attributes and other personal data.

Unique pricing displays are shown for the purchase of the same product by different consumers having different indexes, 7.100-7.700. These price displays provision pricing according to the Pricing Engine determinants. The price set for a purchase or appointment may be varied by the Provider. This Set Price can be the amount paid to the Seller or Provider. It can be a sales price or price for purchase. It can also be a, combined price, group price, cart price, discounted price, promotional price, price after coupon, split price, subsidized price, and the like. It can be an amount. It may be adjusted based on credit card fee.

The Seller or Provider can vary the Set Price on an individual, group, or rule-based basis. The Set Price is then used by the Pricing Engine to provide additional pricing determinants before providing a purchasable price to the Member. In some cases the Seller or Provider may offer a Product or Service without a cost. In some cases the Seller or Provider may offer to pay for a consumer to purchase a Product or Service. A Member can be paid in an amount of all, or a portion thereof, for the purchase or appointment.

Fees may be added before or after the unique price is determined. Adjustments to the price may be added or removed, as discussed elsewhere in this specification. YOUR PRICE is a registered trademark.

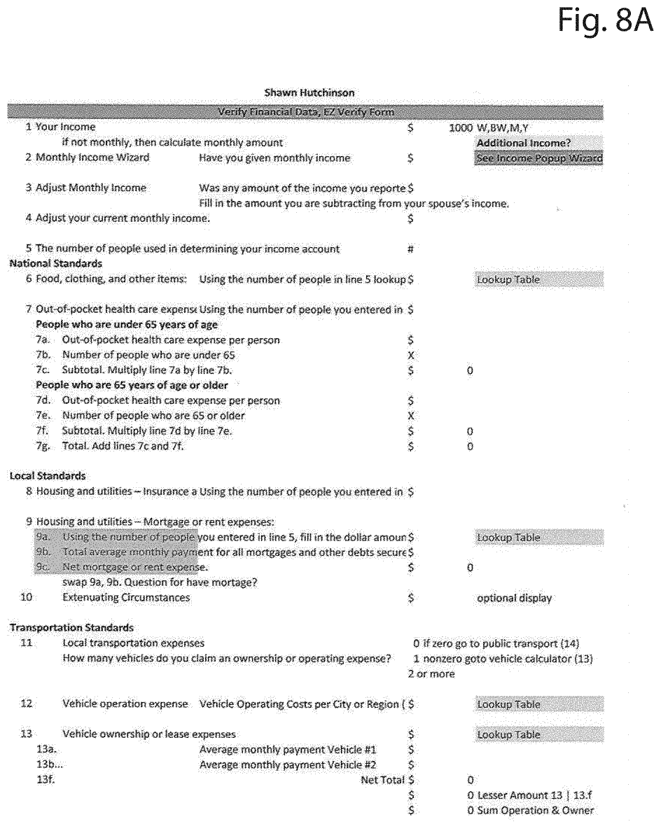

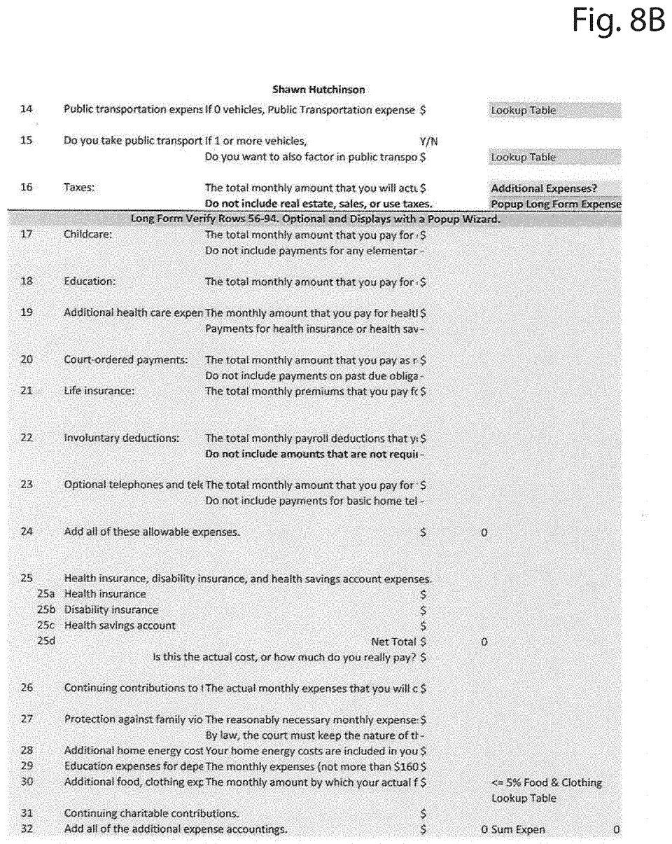

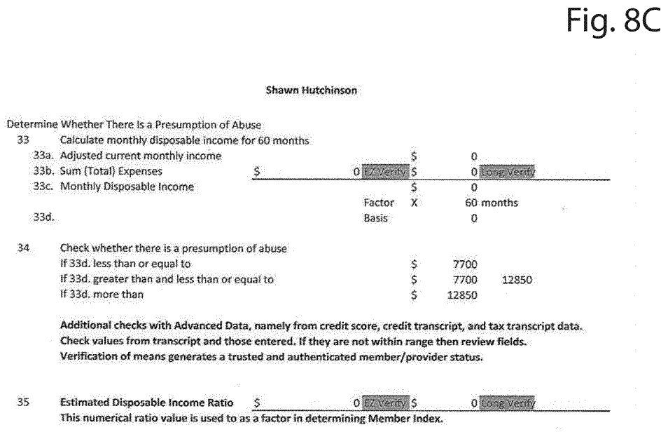

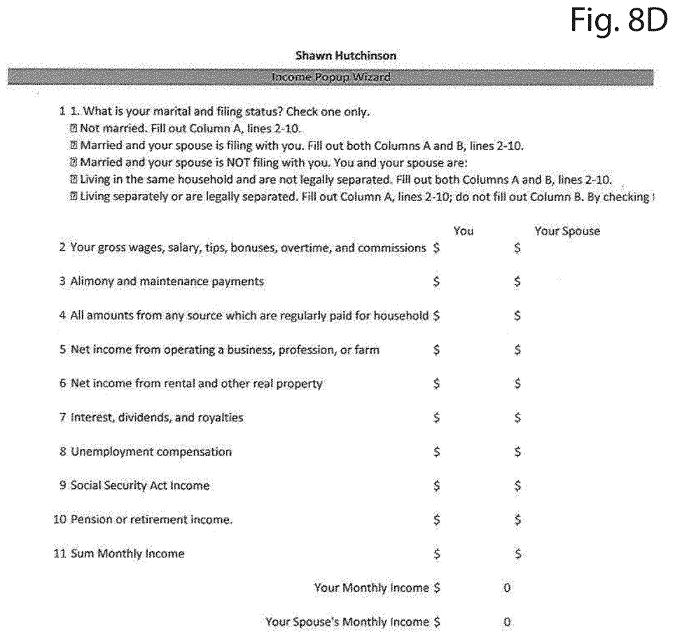

FIGS. 8A-8D. Verify Financial Data. The form process for the Member to input data corresponding with financial information. This data is used to determine the Member Index on account of the Member Index Calculations as in FIG. 3.

Aspects of financial data are included in itemized form. This form may be used by a Member or Provider to determine an index. Attribute data can be about a person, group, family, entity, and the like. Attributes can be grouped into genuses, or types, such as a non-limiting selection of: Income—8.100, National Standards—8.200, Local Standards—8.300, Transportation—8.400, Expenses—8.500, Verification—8.600, Checks—8.700, Estimations—8.800, Spouse Expenses—8.900, and the like, and combinations thereof.

The species of the financial data can include, and are not limited to: income, expenses, national standards, local standards, food costs, clothing costs, number of people in the home, age of people in the home, healthcare, housing, utilities, mortgage, rent, leases, real estate, taxes, vehicles, transportation costs, public transportation costs, gas, fuel, charging costs, transportation standards, childcare, education, healthcare, court-ordered payments, life insurance, involuntary deductions, telecommunication, disability costs, health savings account, home costs, energy costs, food, clothing, gifts, donations, property taxes, income taxes, capital gains taxes, tax, fees, levees, liens, arrears, and like. Species of incomes include, and are not limited to: gross wages, salary, tips, bonuses, overtime, commission, alimony, maintenance payments, household income, income from business, profession, farm, grants, rental property, business property, other property, interest, dividends, royalties, unemployment, social security act income (SSI), payout, pension, retirement, stipend, and gross receipts.

Mathematical, statistical, quantitative, algorithmic operators, and the like may be used to determine the financial contributions. The process can validate financial information about or for the Member or Provider, such as the credit score, credit transcript, reports, tax transcript, and the like. This financial information can be provided, gathered, sourced, obtained, and the like from any available source. The identity of the Member or Provider can be authenticated or validated. One or more of the data can be validated or checked to determine estimate, tolerance level, threshold, confidence level, and the like.

Aggregate data may be determined from one or more attribute data. Statistical data may be determined, including ratios, indexes, coefficients, weights, counts, scores, and the like for use with the Pricing Engine, provision of analytics, aggregates, and the like. They may be used to produce other attributes that may be used for actionable, addressable, or operable attributes with or without pricing, such as data provision, transmission, machine learning, and other processes of using or processing data.

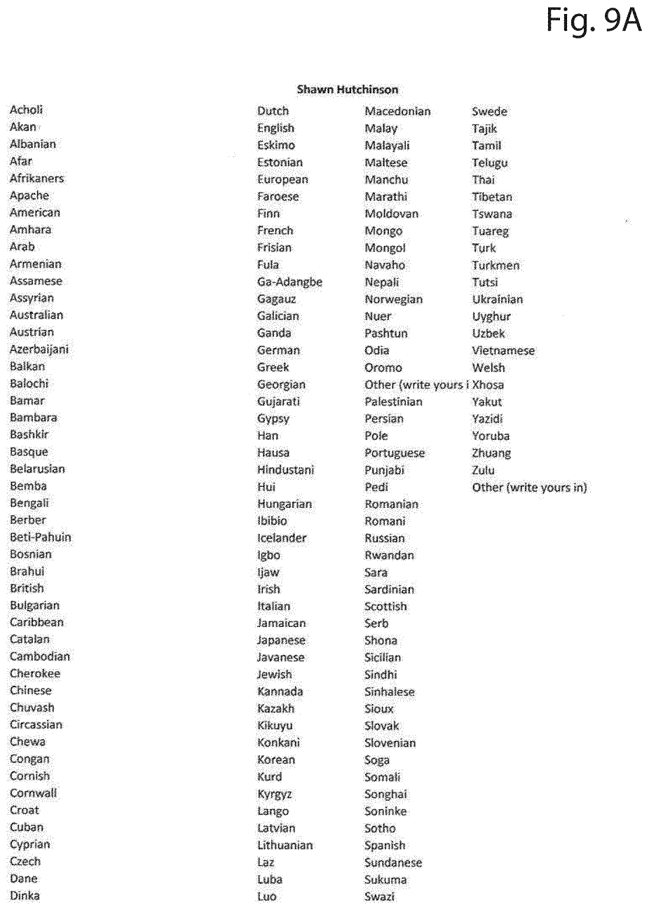

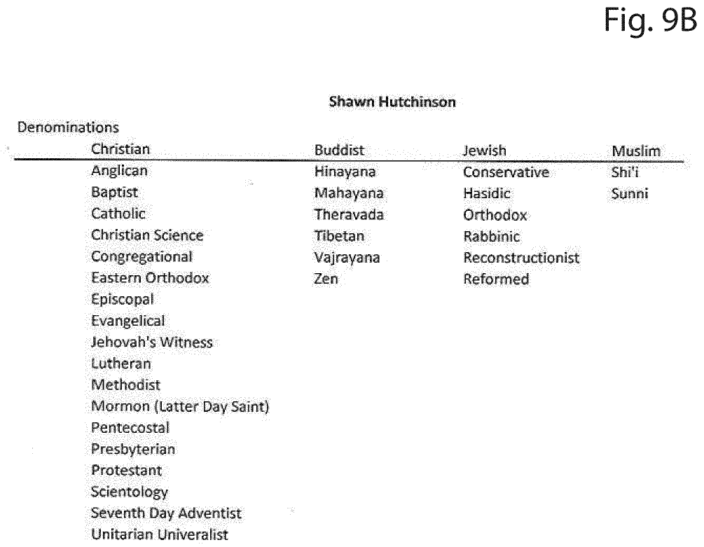

FIGS. 9A-9B. Table of Ethnicities and Denominations Table. Ethnicities that Members specific about themselves, 9.100. Denominations that Members specific about themselves, 9.200. Responses to one or more of these fields can effect the Member Index based on socioeconomic factors, policy, indicators, resources, and the like.

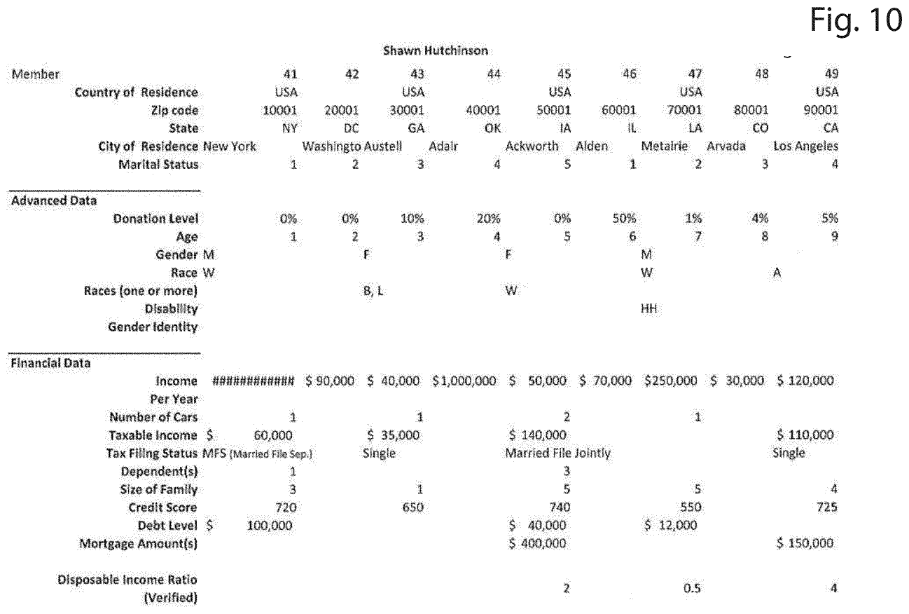

FIG. 10. Member Sample Data that shows sample attribute data. Attribute data can be collected in singular or plural form, for one or any number of attributes. They can be collected before, during, or after a transaction, for example. These are some examples of attributes specified by a user, including Basic Data—10.100, Advanced Data—10.200, and Financial Data—10.300.

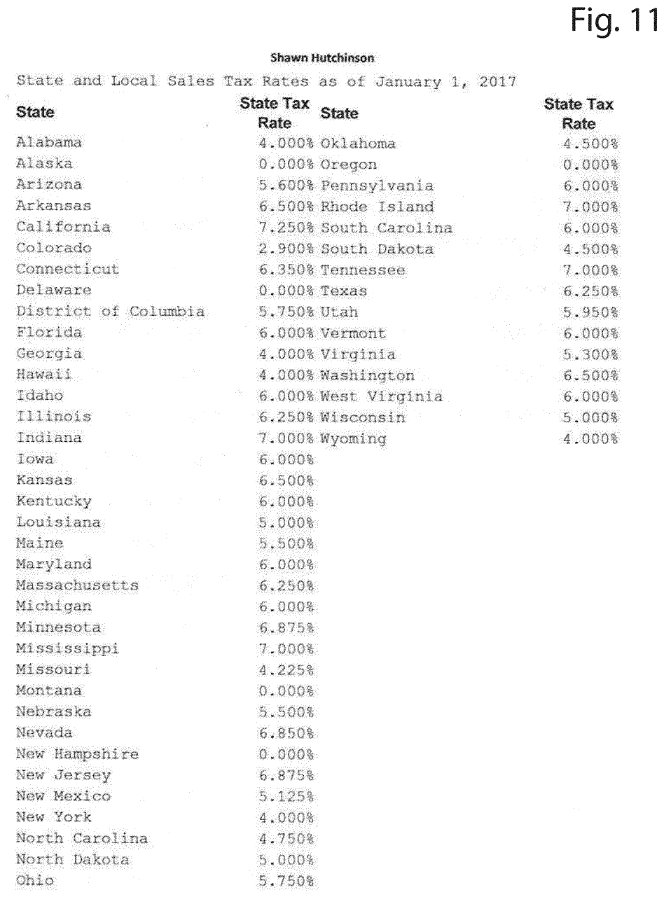

FIG. 11. State Sales Taxes, 11.100. Sales Tax rates used to calculate the amount of sales tax calculated. Sales taxes can be determined based on national, city, state, local, and other forms of public and private taxes. A tax can instead represent one or more fees, tariffs, taxes, liens, and other cost factors that determine prices, accessibility, authentication, verification, validation, and the like, and combinations thereof.

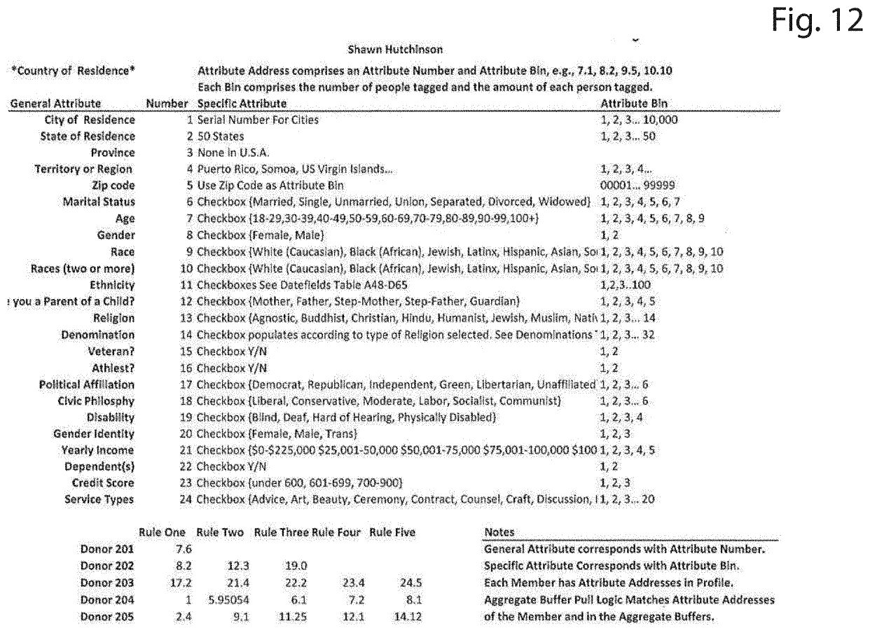

FIG. 12. Attribute Addresses. An attribute can be general—12.100, specific—12.200, and comprise one or more designated reference numbers—12.300. A reference number can correspond with one or more general attribute, specific attribute, and combinations thereof.

Addresses that are assigned to each of the personal attributes. The addresses can be used to refer to data that corresponds with a Member and to a resource buffer. Addresses of attributes are useful in the process of compiling digests of values and numerical states. Digests are further useful in preprocessing data for rapid display and quick sorting. Digests can be generated by preparing data for use in lookup tables, hashes, pointers, and the like, to quickly reference data that has at least one operation performed with, by, on, through, in reference to, as a result of, caused by, caused to, calculated, state changed, indicated, displayed, abbreviated, notified, encrypted, and the like. One example of a digest is to determine member indexes for members and then prices offsets that are available

Attributes can be used to generate addresses to route information to recipients based on one or more types of attributes. These attributes may correspond with any of the attributes defined, referenced, or incorporated by reference herein. They can be defined in relative relation as genus-species. They can be genus attributes, species attributes, subspecies of species, subspecies of subspecies, from 1 to N number of links, relations, forms, associations, similarities, differences, taxonomy, linnean, web, graph, node, array, set, sort, tree, and the like, for example. A genus can have multiple sets of species. A genus can have one species. Species and subspecies can be 0 to N number. For one example, “State” is a genus and the 50 states species of the genus. Subspecies of the state can be counties. State can also be a species of a genus such as Country or Nation which has other types of Districts, Protectorates, Territories, etc. other than a State. A genus can be its own species, such as “Virginia” can refer to a combined region or to the separate States of Virginia and West Virginia.

Attributes can refer to people, entities, businesses, agriculture, animals, creatures, insects, microorganisms, food, buildings, census data, classification systems, economic indicators, energy, federal codes, health and nutrition, insurance, location, medical, opinion, products, materials, taxes, revenue, expenses, telephone numbers, trademarks, zip codes, and the like. They can be values associated with attributes. Attributes can comprise at least a part of a barcode, QR code, rfid, SKU, UPC, GTIN, GPS, GS1, EAN, ASIN, PDF417, 2D matrix, aztec, maxicode, postnet barcode, and the like. A barcode, QR code, rfid, SKU, UPC, GTIN, GS1, EAN, ASIN, PDF417, 2D matrix, aztec, maxicode, postnet barcode, and the like can refer to an attribute address. A non-exhaustive list of attributes in a non-limiting way are referenced above and with references that are incorporated by reference below.

An attribute can have a number associated, referenced, referencing to, pointing to, and the like in order to refer to it using a code. The code is used to indicate the attribute. The possible values of the attributes have another code to indicate further values. These can be called attribute bins, species, genera, and the like, in relative, dynamic, or fixed ways. So, an attribute address for State and Virginia can refer, for example, by 2.32. An address of 7.6 could refer to age attribute and age group 70-90.

Multiple addresses can be used in succession or combined, 8.2-12.3-19.0 or 5.95054-6.1-7.2-8.1, from 1 to N number, 12.400. Sets, sequences, or associations of addresses can determine rules. Rules can be used in aggregate form to address to at least one multitude, in whole or part, 12.500. A multitude can include at least one address, booking, code, data, device, display, domain, card, cookie, beacon, location, pixel, protocol, record, register, session, streaming, tier, transmission, website, and the like, and combinations thereof. An address can comprise a genus without attribute, such as an address of 1 that refers in this case to an unknown attribute of a city. Addresses can be referenced using characters, bits, bytes, quanta, and the like. An address can have one or more of any character, bit, byte, quanta, symbol, and the like used to designate an attribute, genus, or species. Without being bound by theory, the characters, bits, bytes, quanta, and the like that used to indicate an address can be selected, determined, designated, written, indicated, constructed, generated, based on human input, computer, algorithm, artificial intelligence, machine learning, and the like. Addresses can be transformed into one or more modes of transiting data, such as light, wave, electrical state, and the like.

Addresses can be generated using any alphanumeric sequence, symbol, designation, reference, string, sequence, code, attribute, genus, and the like. One or more addresses can be appended, combined, prepended, sequenced, concatenated, generated, constructed, changed, compiled, recompiled, determined, redetermined, set, reset, preset, recorded, saved, stored, transmitted, and the like. An address can be used with other addresses, codes, program code, link, pointer, and the like. An address can link, refer to, call, embed, associate, correlate, refer to, point to, authenticate, verify, and the like in a static, dynamic, causal, changed, changing, changeable, encrypted, fixed, triggered, and like ways. One or more addresses can be linked, referred to, called, embedded, associated, correlated, refer to, pointed to, authenticated, verified, and the like in a static, dynamic, changed, changing, changeable, fixed, triggered, and like ways.

The attribute address can be used to do one or more of transmit, stream, sort, route, action, associate, change, correlate, direct, display, embed, filter, generate, request, retrieve, store, stack, sequence, append, modify, determine, prepend, link, construct, calculate, produce, provision, purchase, sell, book, transfer, call, confirm, perform an operation, cause an action, cause an action, and the like for one or more of data, bit, byte, filter, function, program, script, smart contract, stream, money, currency, crypto, credit, debit, incentive, reward, resource, content, advertising, asset, file, notification, embed, and the like. An address can be a part of data, bit, byte, filter, function, program, script, smart contract, stream, money, currency, crypto, credit, debit, incentive, reward, resource, content, advertising, asset, file, notification, embed, and the like. Addresses can be displayed on a digital display. They can be linked to other addresses, booking, code, data, device, display, domain, card, cookie, beacon, location, pixel, protocol, record, register, session, streaming, tier, transmission, website, and the like, and combinations thereof. One or more addresses can be used at one or multiple points in time.

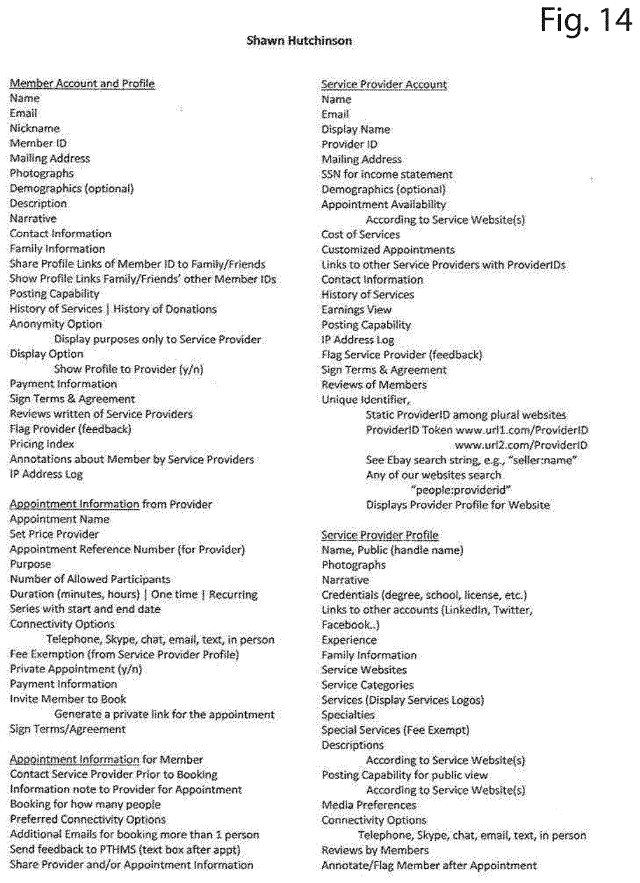

FIG. 14. Member Account and Provider Account Profiles. Data and information that is displayed to one or more Members, 14.100, and Providers, 14.200. Examples of attributes for a Person (Member Account and Profile), entity (Service Provider Account), Appointment Information for a Person (Member), Appointment Information for an Entity (Provider).

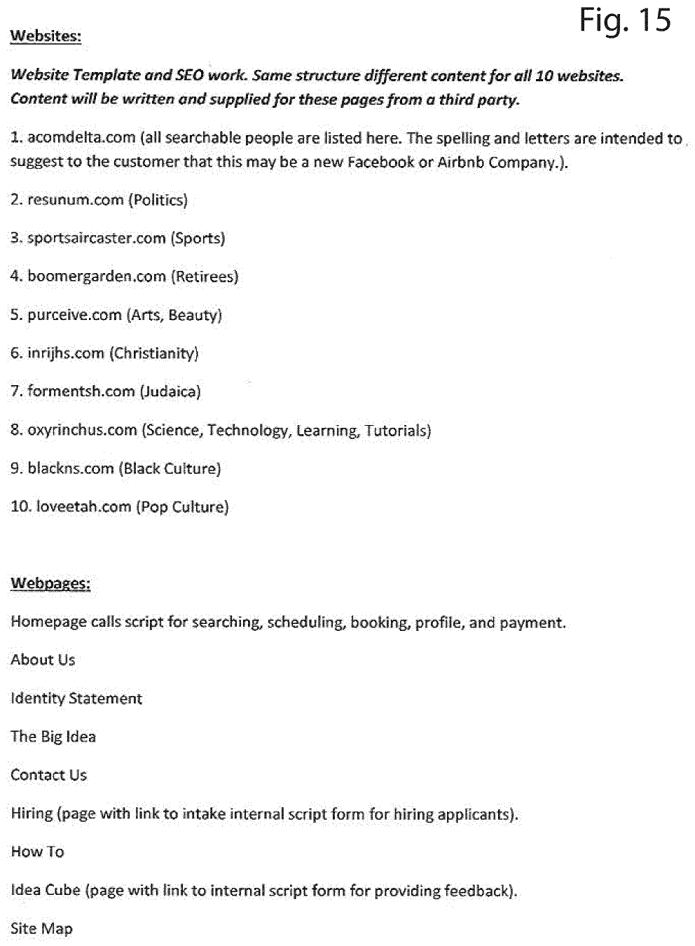

FIG. 15. Websites and Webpages. The websites that display Member and Provider Profile information, 15.100, and where bookings are made and payments collected. Websites domains can use any top level domain or generic domain. Attribute addresses can be used in a uniform resource locator (URL). They can be used with pages, content, program calls, and any functionality at a domain. Website and webpage functions can include in non-limiting examples: searching, scheduling, booking, profiles, payments, allocating, resources, processes, procedures, scripts, programs, APIs, and the like. Attributes can be referenced for use with a parameter, function, call, API, and so forth. They can be used in, with, referenced by, point to, encrypted from a URL, and the like.

Attribute addresses can be used to transmit or receive data to and from different domains, webpage, app pages, and the like. Content can be provisioned to different domains from a single source. Data can be gathered from different domains into a single source. Prices can be displayed using addresses through these domains, webpages, app pages, and the like. Prices can be different according to the person viewing the price on a domain, webpage, app page, and the like. Addresses can comprise advertising, pricing, promotions, content, videos, pictures, and buttons to display or gather data using attribute addresses. Addresses can be used to channel information in similar ways across different display mechanisms. Similarly, one or more booking, code, data, device, display, domain, card, cookie, beacon, location, pixel, protocol, record, register, session, streaming, tier, transmission, website, and the like, and combinations thereof may be used to channel similar information to different locations.

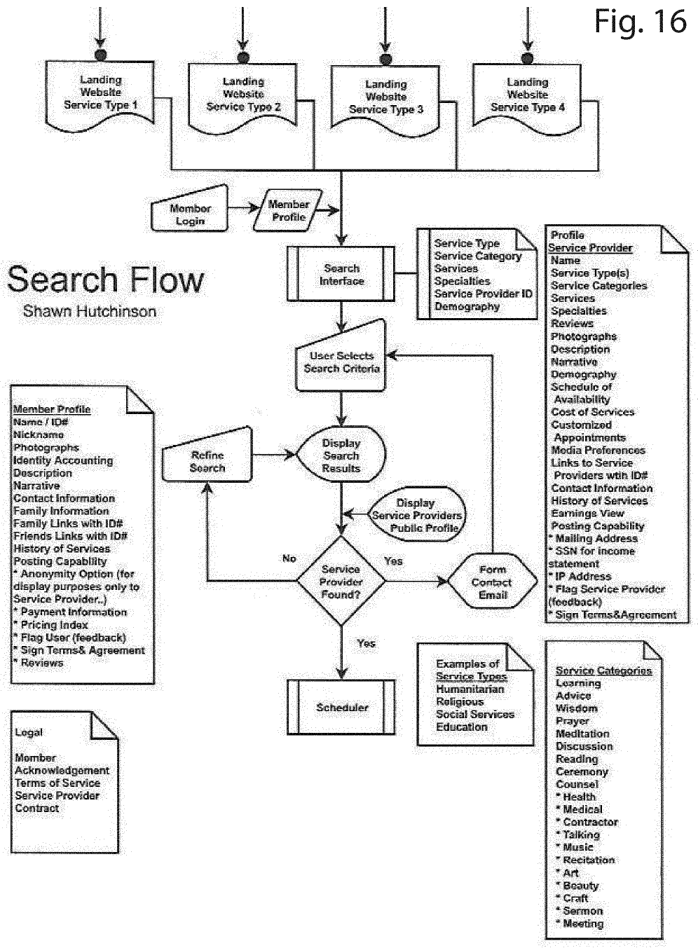

FIG. 16. Search Flow. Flowchart that shows the search and display platform that serves one or more websites as well as Members and Providers, 16.100. A search engine uses attributes to display one or more content, image, video, sound, text, character, link, symbol, emoji, and the like, and combinations thereof according to attributes of one or more person, provider, entity, bot, app, program, and the like, and combinations thereof, 16.200. One or more attribute or addresses can be used to transmit, stream, sort, route, action, associate, change, correlate, direct, display, embed, filter, generate, request, retrieve, store, stack, sequence, append, modify, determine, prepend, link, construct, calculate, produce, provision, purchase, sell, book, transfer, call, confirm, perform an operation, cause an action, cause an action, and the like, 16.300. Personalized data can be provided based on the person, entity, or program that is addressing, viewing, or provisioning data, and the like, 16.400. Categories may be used to alter the appearance of a page or provide data that is accessed using attribute addresses, 16.500, which may be based on a Member, Provider, or any user.

One or more landing page websites use a search engine that has a search interface. The search engine may or may not require login for the user using the search engine. The search interface for the search engine can specify types of services, for example, as sources of input or filters of display. The user inputs search criteria and search results are displayed. The results can be determined at least in part by using attributes of the user's profile. The results can be determined at least in part by using an address to the user that corresponds with attributes. These attributes can be set by the user or determined by an entity, such as a company, program, machine learning, artificial intelligence, third-party service, and the like.

Attributes based on one or more provider, seller, entity, and combinations thereof can be used to determine the content, pricing, and ads. Attributes can refer to words, keywords, meaning, value, emotions, affects, clicks, history, ratings, reviews, costs, preferences, links, and so forth, for example, based on past performance. Attributes can be derived from these values using categories, themes, labels, topics, genus, species, subspecies, types, interpolations, learning, procedures, summaries, and the like. Attributes can be derived, formed, interpolated, informed, insighted, learned, supervised, synthesized, and combinations thereof.

Attributes based on one or more types of services or products can be used to determine the content, pricing, and ads. Attributes can refer to words, keywords, meaning, value, emotions, affects, history, ratings, reviews, costs, preferences, links, and so forth, for example, based on past performance. Attributes can be derived from these values using categories, themes, labels, topics, genus, species, subspecies, types, interpolations, learning, procedures, summaries, and the like. Attributes can be derived, formed, interpolated, informed, insighted, learned, supervised, synthesized, and combinations thereof. These attributes can be used to do one or more of provide results, schedule appointments, book, contact, surf, search, and the like.

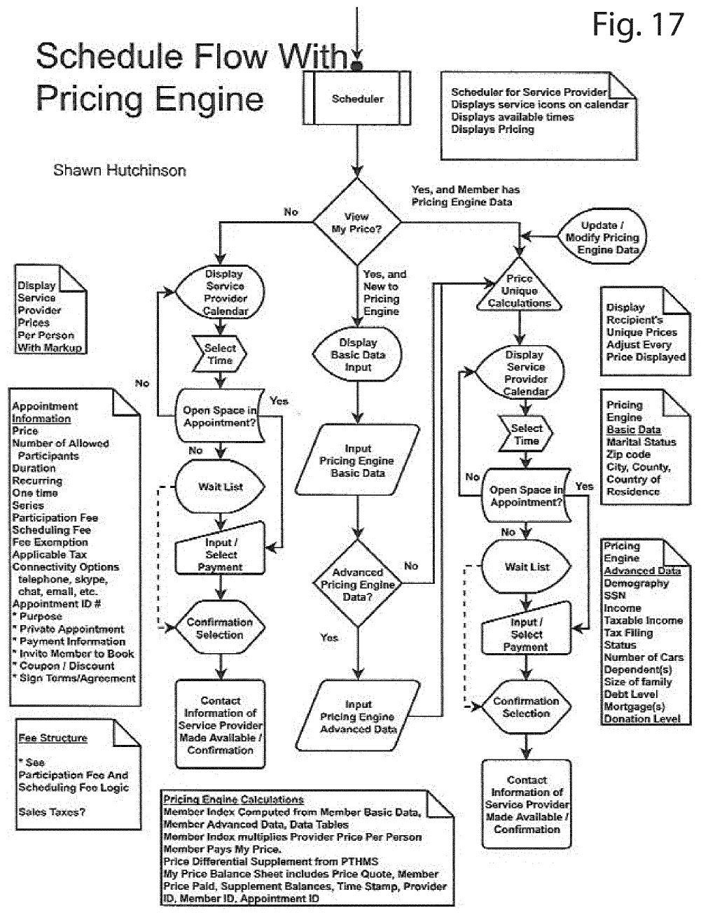

FIG. 17. Schedule Flow With Pricing Engine. Flowchart that shows the possible displays of prices according to the data that the Member providers in terms of personal attributes. A scheduling engine uses attributes to display content, image, video, sound, text, character, link, symbol, emoji, and the like according to attributes of one or more person, provider, entity, bot, app, program, and the like, 17.100. One or more attribute or addresses can be used to transmit, stream, sort, route, action, associate, change, correlate, direct, display, embed, filter, generate, request, retrieve, store, stack, sequence, append, modify, determine, prepend, link, construct, calculate, produce, provision, purchase, sell, book, transfer, call, confirm, perform an operation, cause an action, cause an action, and the like. Personalized data can be provided based on the person, entity, or program that is addressing, viewing, or provisioning data, and the like, 17.200. Categories may be used to alter the appearance of a page or provide data that is accessed using attribute addresses.

Appointment data can be used as attributes to determine addresses used to provision content, prices, ads, and the like for programs, domains, webpages, app pages, and the like, 17.300. Additional data about a person or entity may be used to provision this. For example, a medical appointment may use other codes related to medication, medical condition, or procedures. Attributes or addresses constructed with this information can be used to provision content, personalized prices, ads, and the like, 17.400. These attributes can be used to do one or more of provide results, schedule appointments, book, contact, surf, search, and the like, 17.500.

A scheduler is used to provide data to a user. It can be to provide a schedule of data, like data tables, streams, digests, any activity that has a database, table, memory, excel, plan, and the like. It can be used to schedule an appointment, activity, event, sequence, workflow, supply chain, access, resources, any activity that has a sequence or time dependent parameter, and the like.

The schedule example determines a critical attribute to sort the conditions of the schedule. In this example, whether personalized pricing is to be provisioned. If not, appointment information is provided for a user to select based on criteria that is provided for the user to make selections. Information about the schedule is determined by the type of user. Selections are presented according to the attributes of the schedule. These can be provided as further options to the user to select among. Confirmation of the selection can be used to schedule an allocation of resources.

If personalized pricing is provided, the scheduler can invoke the pricing engine to determine prices for the user, 17.600. These prices can be unique based on attributes used to determine for pricing, they can be used as addresses to the display, to the pricing engine, and combinations thereof. Addresses can be tied with sessions, devices, cache, status, and the like to adjust the price that is shown. This can be shown as a sum, total, supplement, subsidy, discount, credit, and the like.

The address can be used to activate a price as a programmable data record. For example, a program can retrieve a price from a server for a product. The address can be used to retrieve a price from a server for a product and receive a price credit for a user, for a product, and combinations thereof. The address can be used to send and receive information based on a user, product, entity, program, bot, algorithm, procedure, artificial intelligence, and the like. The address can be used as an input/output cell that is reachable and retrievable using one or more combinations of attributes, attribute addresses, and the like. The cell can be on a device, session, program, page, app, and the like. The cell can perform functions on the data or have functions performed on it, to it, by it. The cell can be at least one cell, register, record, virtual cell, page, table, a digital state, and the like, and combinations thereof, that can be used to perform an operation or store a value.

Performing a function can be an operation, action, activity, trigger, send, receive, calculate, shift, computation, and the like. It can be a bit register that is delocalized from a machine, chip, device, server, session, other address, and the like. It can be a bit register that is delocalized from a machine, chip, device, server, session, other address, and the like that has access to it. Delocalized can be decoupled, decentralized, detached, disaggregated, discharged, separate, and the like. It can exist as a part of a program or separate from it. It can be accessible through, by, with, from a server, program, interface, link, pixel, user, code, email, telephone number, IP address, device address, serial number, account number, wallet, and the like. A cell can be, include, be within, be included by, or associated with a state, chip, computer, compiler, executable, program, record, renderer, script, bin, register, medium, memory, app, API, and the like.

A price is addressable using an attribute address as defined herein, like routing number to a bank account, with some price credit, for example, that reaches the session, display, device, program, and the like to affect an adjustment in a price, 17.700. The price can be treated on an individual basis like an account, so that the credit or debit to the price that is routed with the attribute address is used to add or subtract from the sum needed to complete a purchase or transaction. The Prices can be adjusted, 17.800, according to the methods discussed herein. Content in the form of photos, buttons, links, likes, emojis, videos, streams, and the like may be provided using the address separately or combined with the price adjustment. The addressable data record can send or receive data. This data can be used to display information or send data for the purposes of addressing, aggregating, analytics, authenticating, calculating, computing, confirming, encrypting, identifying, notifying, paying, programming, recognition, securing, transacting, validating, verifying, and the like.

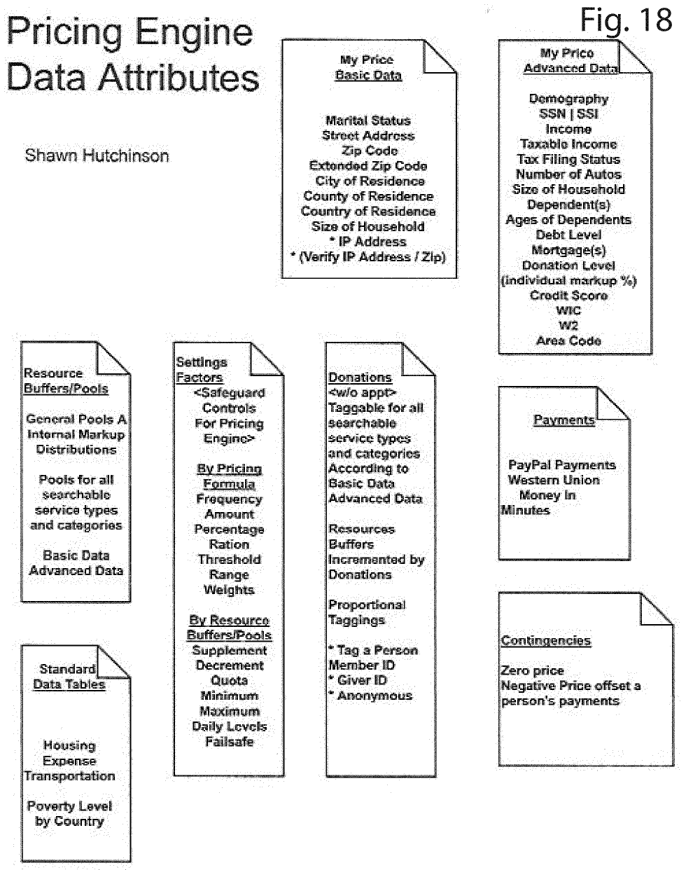

FIG. 18. Pricing Engine Data Attributes. Addressable attributes that are useful in numerical interpretation of affect and value. These include examples of genuses of attributes, such as Basic Data, Advanced Data, Buffers/Pools, Factors, Donations, Payments, Data Tables, and Contingencies. Species of attributes are shown with each example attribute genus.

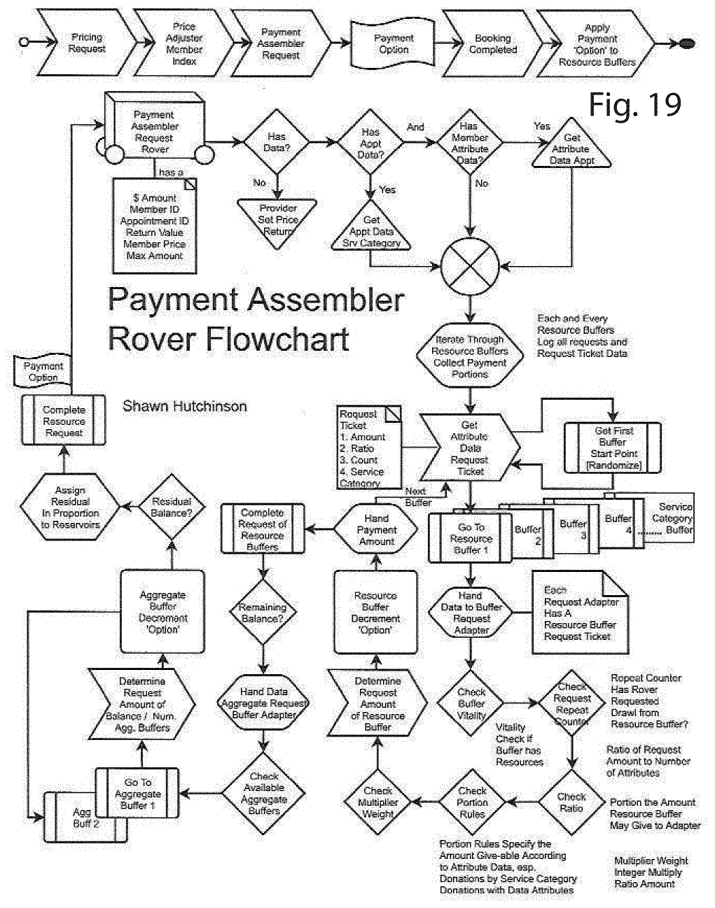

FIG. 19. Payment Assembler Rover Flowchart. A procedure for bundling payments wherein one or more sources of funds are assembled and then bundled into a sum for a purchase transaction.

A flow chart, 19.100, shows a process flow for a use of the pricing engine. A request for a price is received, a price is adjusted using a member index, a payment is assembled, a tendered payment is prepared, a booking for an appointment is made, and a payment is processed. A booking can be one or more of an appointment, purchase, payment, request, click, search, schedule, and combinations thereof. A booking can include one or more of an appointment, purchase, payment, request, click, search, and combinations thereof.

A payment can be assembled with one or more algorithm, program, process, procedure, script, webpage, page, pipe, app, API, virtual, website, and the like. The assembler can traverse a series of determinations to determine if a user has provided data, such as any personal data, appointment data, attribute data, and combinations thereof, 19.200. The user can enter such data. The user can proceed to the processor to determine resources available. The user can be a person, process, algorithm, script, app, application, procedure, webpage, page, pipe, API, virtual, website, and the like, and combinations thereof. The processor can be a schedule, booking, payment, display, allocator, and the like type engine. The processor can go through an iterative process of determining resources available for one or more attributes.

The processor can traverse one or more steps in determining whether resources are available for one or more attributes, 19.300. The processor can traverse one or more steps in determining how much resource is available for one or more attributes. The processor can traverse one or more steps in determining how many resources are available for one or more attributes. The processor can traverse one or more steps in determining when resources are available for one or more attributes. Each step can include one or more substeps, rules, and the like to determine attribute or resource availability, 19.400. A step can include one or more steps of requests, category, authentication, verification, check, comparison, amount, ratio, weight, vitality, counters, numbers, permissions, rules, decrement, increment, semaphores, and the like. If a resource is available, the resource is made available to complete the request from an account, buffer, and the like, and combinations. If a resource is available, the process can continue until one or more available resources are determined. If a resource is available, the process can continue until all available resources are determined. If a resource is not available, the process can continue until a resource is available. If a resource is not available, the process can complete without available resources.

To complete the process, the processor records one or more changes to one or more accounts, buffers, and the like, 19.600. One or more steps for completing the process can include one or more requests, category, authentication, verification, check, comparison, amount, ratio, weight, vitality, counters, numbers, permissions, rules, decrement, increment, semaphores, and the like, and combinations thereof. One or more changes can be made to an account, buffer, and the like. The change can be an increase, decrease, hold, reserve, increment, decrement, counter, calculation, allocation, assignment, spread, and the like. One or more available resources is provided to the assembler. A payment can be one or more price, monetary amount, currency, crypto, computational unit, operation, power, electronic state, transaction, measurable unit, and the like. One or more additional information can be included with the payment, such as identification number, value, inherited feature (i.e., “has a”), and the like, and combinations thereof. The process provides the payment option to the user for completing an action.

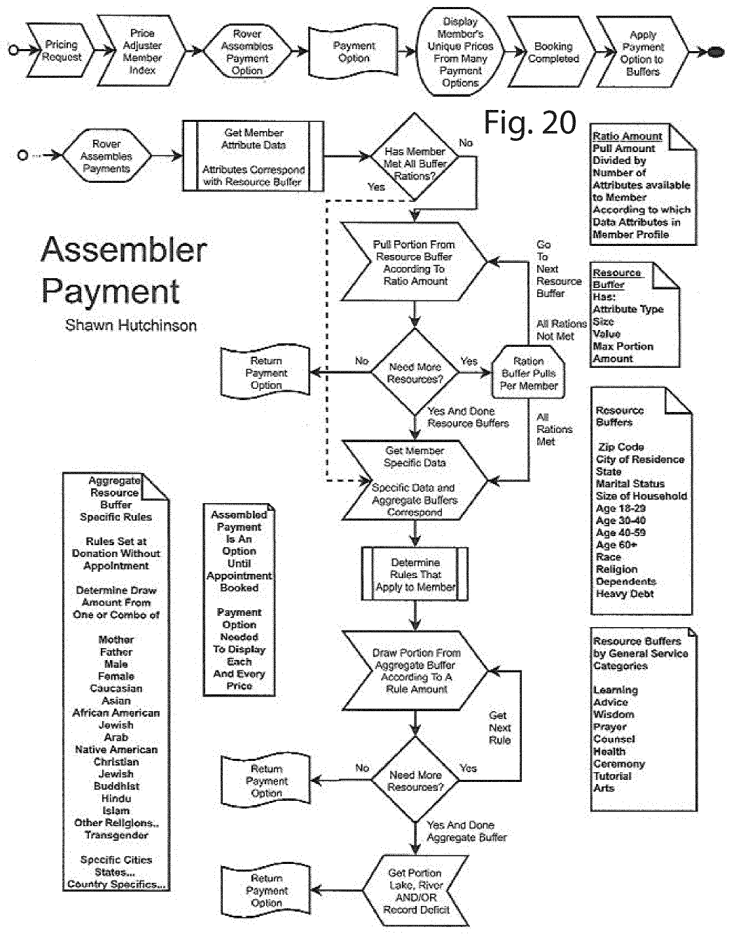

FIG. 20. Assembler Payment. A procedure of a payment assembler as a payment is bundled.

A flow chart, 20.100, shows a process flow for a use of the pricing engine. A request for a price is received, a price is adjusted using a member index, a payment is assembled, a tendered payment is prepared, one or more options are provided to the user, a booking for an appointment is made, and a payment is processed. A booking can be one or more of an appointment, purchase, payment, request, click, search, and combinations thereof. A booking can include one or more of an appointment, purchase, payment, request, click, search, and combinations thereof.

An assembler can operate with one or more features, steps, processes, and the like as in FIG. 19. An assembler can include one or more steps to determine resources available, 20.200. Available resources may include attributes that pertain to the user. A user may have one or more attribute resources available based on attributes of the user. These may be accessible in an account or buffer, 20.300. A user may have one or more attribute resources available based on one or more process, machine, hardware, subscription, schedule, and the like, and combinations thereof.

A process can continue until all available resources are determined, used, allocated, and the like, 20.400. A resource can be pulled from one or more account, buffer, pool, and the like, and combinations thereof. Rules may be used to determine how much resource is available, pulled, committed, reserved, allocated, and the like, 20.300. Resource pools can be available based on genus, species, subspecies, and the like relations among one or more attributes, 20.400. These can pertain to one or more user, a service, product, content, media, advertising, data, bits, bytes, and the like, and combinations thereof. They may pertain in one or more tandem, sequence, series, at different times, places, machines, nodes, apps, procedures, registers, pixels, and the like.

To complete the process, the processor records one or more changes to one or more accounts, buffers, and the like, 20.700. One or more steps for completing the process can include one or more requests, category, authentication, verification, check, comparison, amount, ratio, weight, vitality, counters, numbers, permissions, rules, decrement, increment, semaphores, and the like, and combinations thereof. One or more changes can be made to an account, buffer, and the like, 20.600. The change can be an increase, decrease, hold, reserve, increment, decrement, counter, calculation, allocation, assignment, spread, and the like. One or more available resources is provided to the assembler, 20.800. A payment can be one or more price, monetary amount, currency, crypto, computational unit, operation, power, electronic state, transaction, measurable unit, and the like, 20.900. One or more additional information can be included with the payment, such as identification number, value, inherited feature (i.e., “has a”), and the like, and combinations thereof. The process provides the payment option to the user for completing an action, 20.1000.

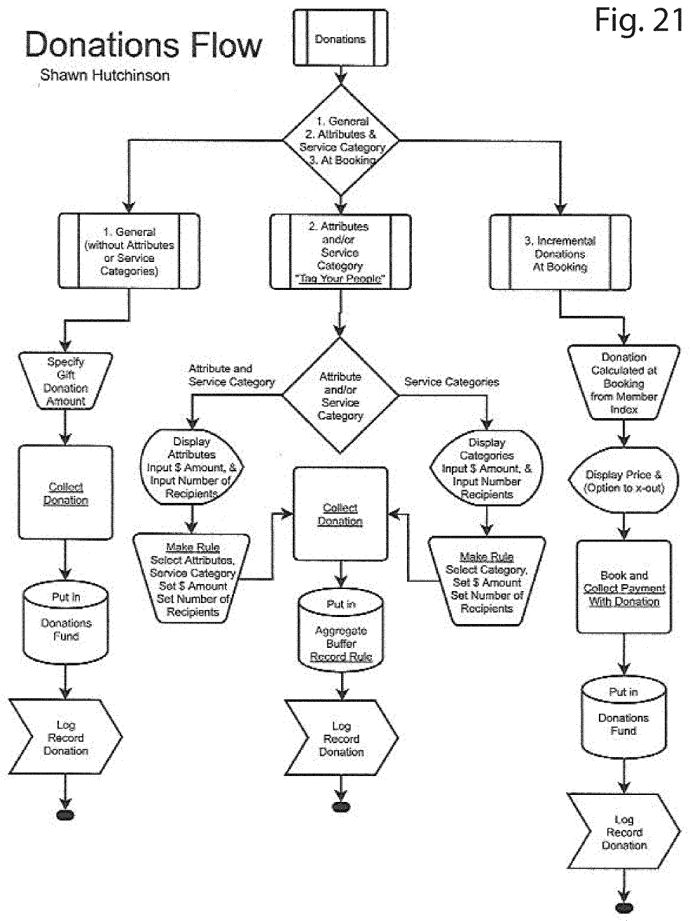

FIG. 21. Donations Flow. A procedure for a Member to make rules according to affect and value for the Aggregate Buffer. Donations are ways of making resources available, 21.100.

Attributes can be used to record resources for bins associated with attributes. These can be general attributes, specific attributes, and may be gathered from user interactions, at booking for example, 21.200. Rules are addressable. Rules are useful for assembling payments to bundle. Donations are additions of resources from a third-party, user, account, algorithm, buffer, program, process, procedure, script, webpage, page, pipe, app, API, virtual, website, and the like, and combinations thereof. Attributes can be determined according to general, specific, user, provider, policy, rules, and the like, and combinations thereof, 21.300. A donation of a resource can be collected, 21.400. A donation can of a resource can be one or more recorded, allocated, assigned, paid, invoiced, future, committed, contracted, reported, queued, and the like, and combinations thereof. Donations can be put or pulled, 21.500.

Attributes can be specified with a resource regarding how the resource can be used, its availability, determined, provisioned, allocated, assigned, paid, invoiced, future, committed, contracted, reported, queed, and the like, and combinations thereof. Attributes can include further attributes, categories, genuses, species, subspecies, and the like. These options can be provided to a pricing engine. A user can interact with donations through requesting a price or payment option. A donation can be recorded for an anonymous customer. A donation can be made by a third-party for another user, account, algorithm, buffer, program, process, procedure, script, webpage, page, pipe, app, API, virtual, website, and the like, and combinations thereof.

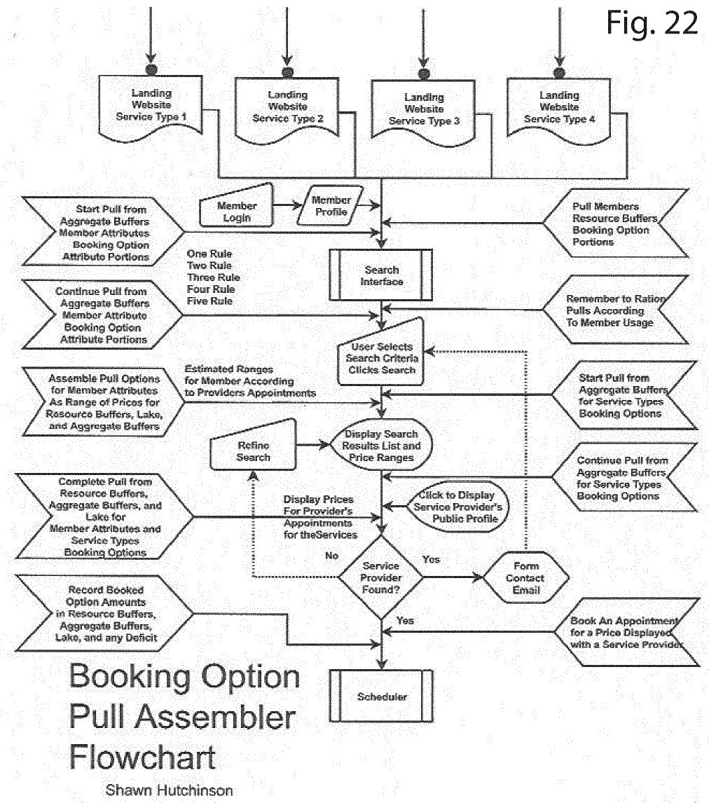

FIG. 22. Booking Option Pull Assembler Flowchart. Flowchart that shows the search and display platform that serves one or more websites as well as Members and Providers, 22.100.

Interpreting a digest of value and affect in order to display search data to a Member in one or more sequences of time, click, flow, operations, procedures, linear, non-linear, called, interrupted, triggered, and the like, and combinations thereof. A search interface can be one or more locator, hash locator, engine, pricing engine, payment engine, rover, assembler, appointment, booking engine, scheduler, function, get, retrieval, query, command, prompt, and the like, and combinations thereof, 22.200. A user can be a person, process, algorithm, script, app, application, procedure, webpage, page, pipe, API, virtual, website, and the like, and combinations thereof, 22.300. A booking can be one or more of an appointment, purchase, payment, request, click, search, schedule, and combinations thereof, 22.400. Attribute resources can be provided along a series of interactions. In this case, an example series of interactions, is a search flow where user enters search information, selects criteria, displays results, provides prices, adjusts prices, refines search, shows profile information, select service provider, contacts, links, and schedules, 22.500. One or more of the steps for providing an option, price, resource, and the like can be used. Puts, pulls, and the like can be interjected at desired locations along the timeline to generate data, value, and the like.

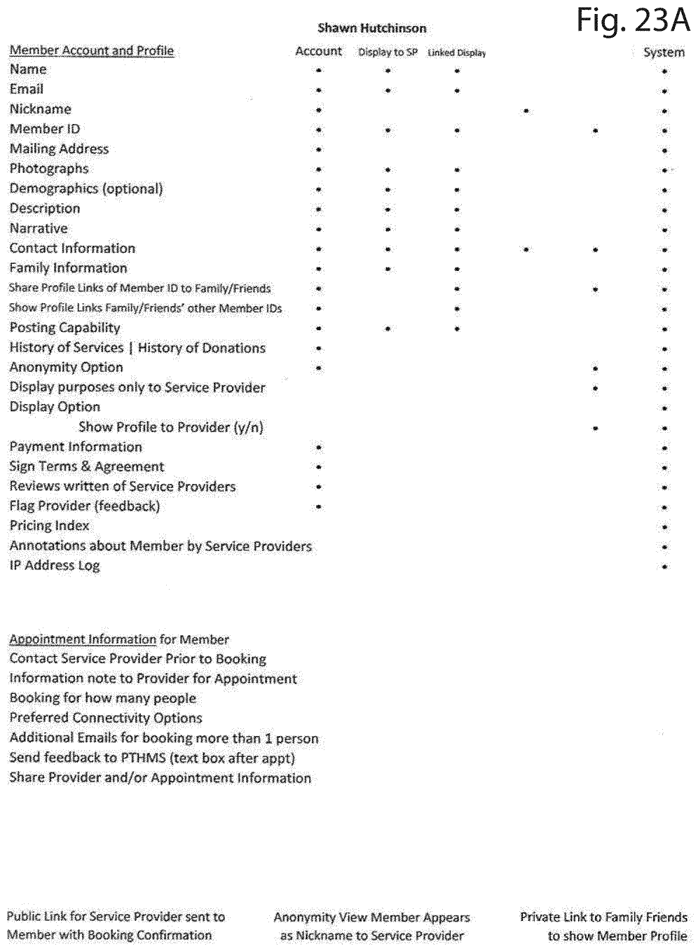

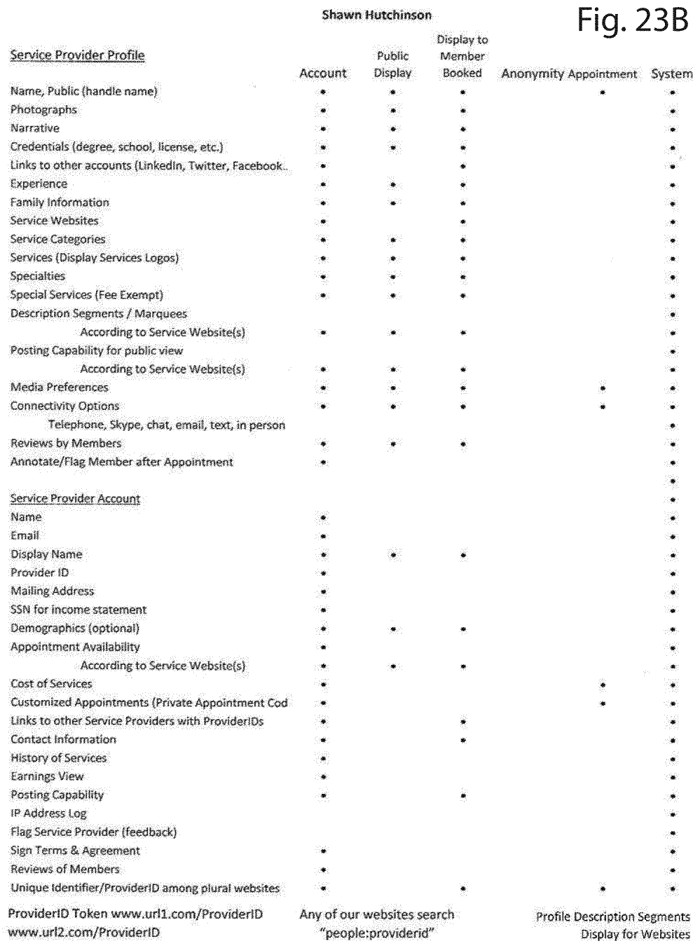

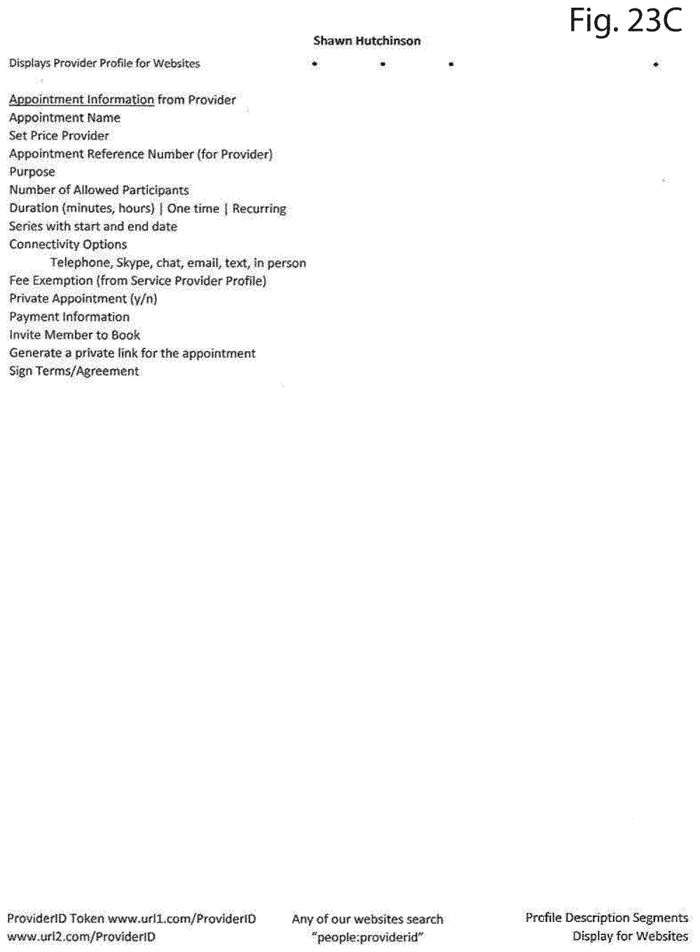

FIGS. 23A-23C. Account and Profile. Display of data according to customized affect and value. An attribute can have further attributes regarding usage. These can include authentication, display, view, permission, validation, verification, anonymity, admin, system, resources, buffers, accounts, and the like, 23.100 and 23.100B. Types of attributes can be attributed to users, displays, records, functionality, and the like, 23.200 and 23.200B, represented by dots. Usage attributes can be used on a dashboard, algorithm, program, process, procedure, script, webpage, page, pipe, app, API, virtual, website, and the like. Usage attributes can be changed by a user. The user can be a person, member, provider, process, processor, algorithm, script, app, application, procedure, webpage, page, pipe, API, virtual, website, and the like, and combinations thereof. Usage attributes can be used to cause an action, operation, command, and the like on another attribute, non-user attribute, user attribute, and the like. Attributes can be linked to one or more product, appointment, user, usage attributes, and combinations thereof, 23.300 and 23.300B.

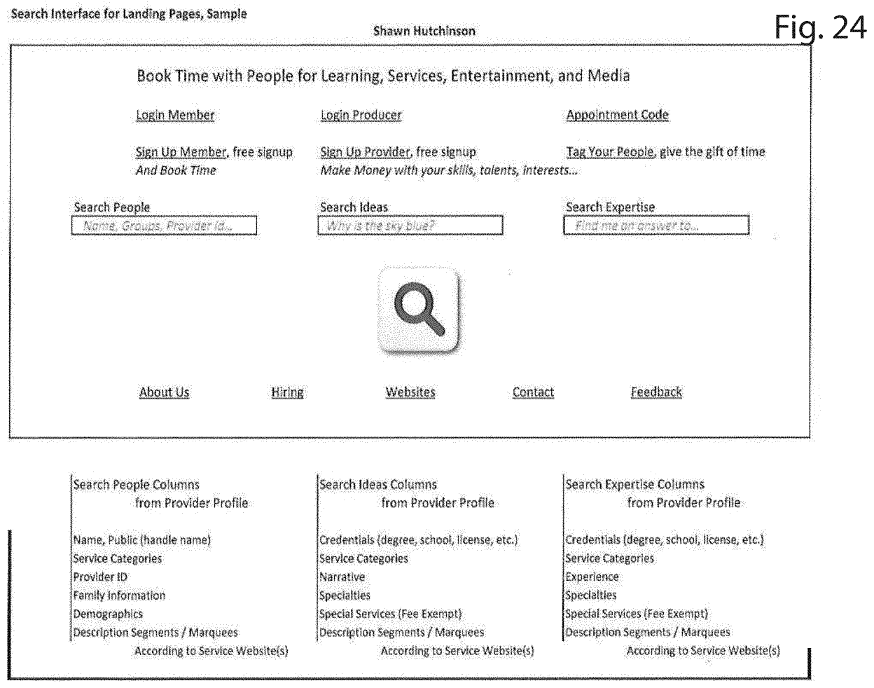

FIG. 24. Search Interface. A search interface displays interpretive data in combination according to one or more addressable attributes and values, 24.100. One or more websites can display information according to attributions, usage attributes, options, prices, appointments, bookings, scheduler, computational resources, and the like, 24.200. One or more attributes can be used to provide one or more search interface. Attributes can be used with search results to do one or more contextualize, determine, refine, narrow, identify, provide, provision, and the like, and combinations thereof. One or more attributes can be used to inform, teach, train, learn, direct, supervise, one or more provisions of search results from a process. A process can be one or more algorithm, program, process, procedure, script, webpage, page, pipe, app, API, virtual, website, and the like, and combinations thereof. Attributes can be a genus, species, subspecies, usage attribute, and the like, 24.300. General category of attributes can be linked, such as a non-limiting example, people, ideas, and expertise. Any genus or species of attributes can be used, 24.400. A user can interact to change one or more attributes to impact the results of the search.

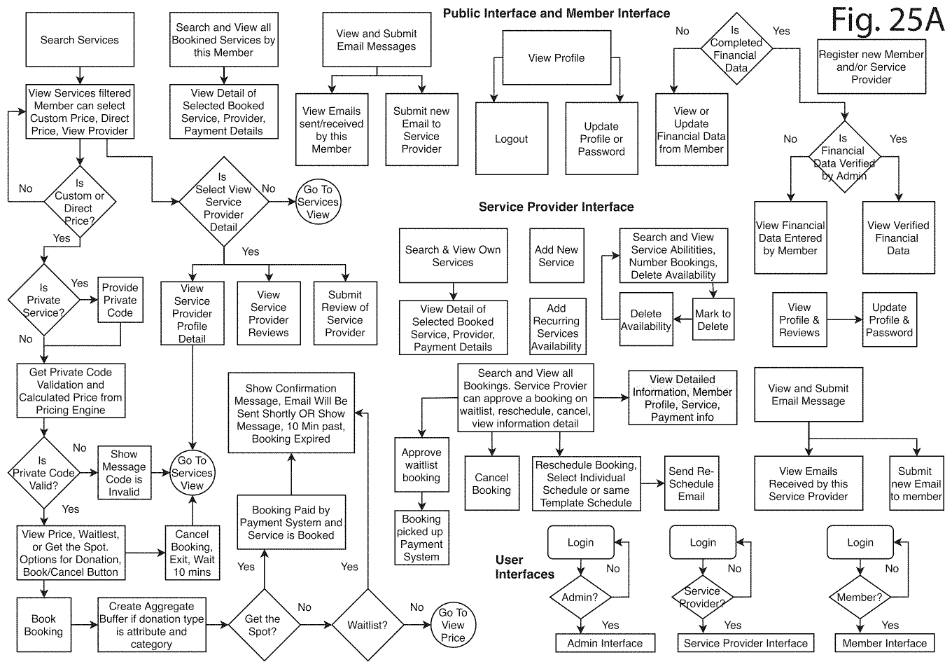

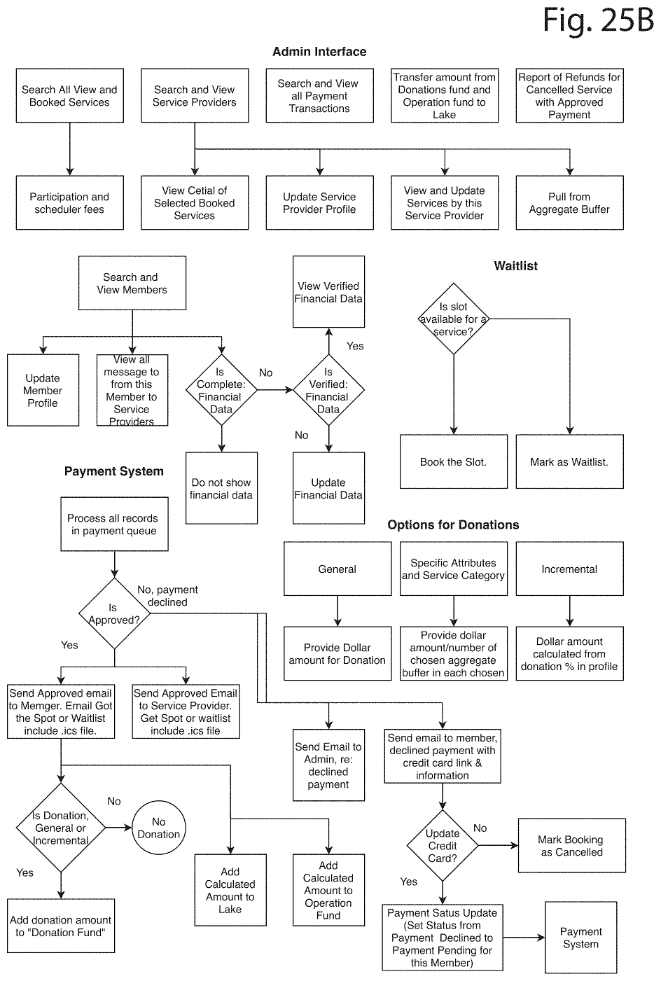

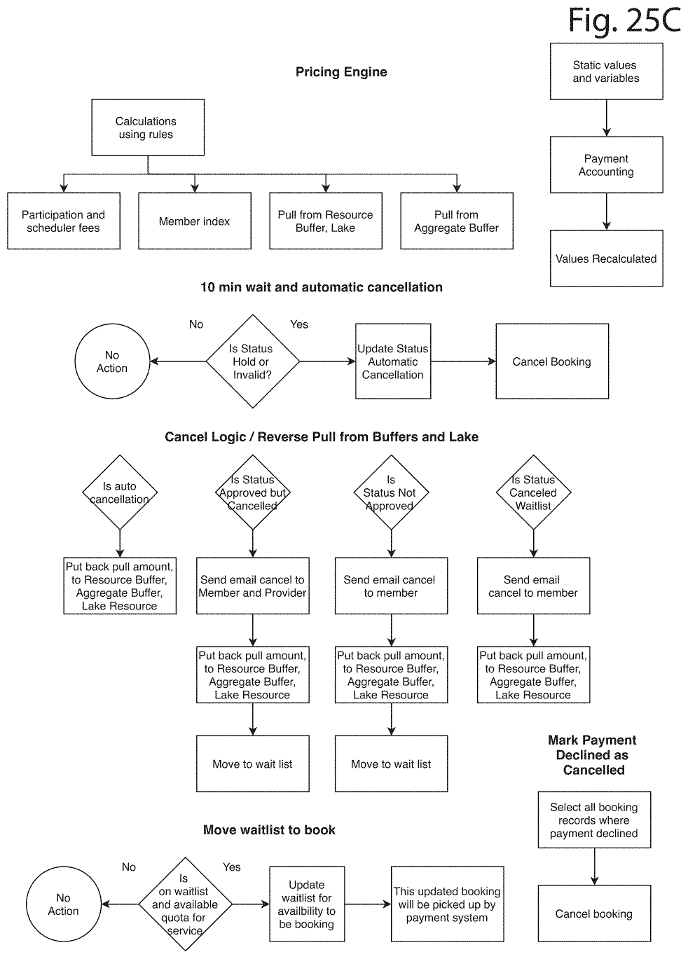

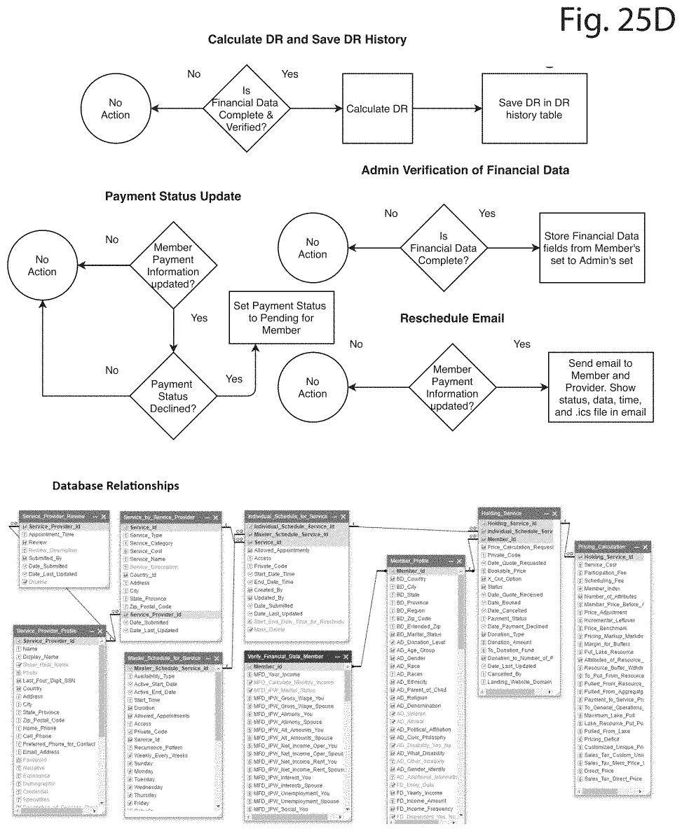

FIGS. 25A-25E. An Application Procedure Workflow describes the interfaces and flow of work processes according to the Embodiments that implement the system according to FIGS. 1-24. Each flow provides more embodiments of methods of determining attributes or values from them. Work process steps are examples of processes that perform operations on one or more attributes, usage attributes, and combinations thereof. Attributes can be stored in a database and have one or more relationships, definitions, links, and the like among them.

### Further Embodiments

An application for scheduling, managing services and calculating unique prices for its booking. Public users can search for services, view services, view service providers profile and their reviews. They can also register to become a member or service provider. Members can search for services, book the service, send emails to service provider, view all booked services, cancel the service and view/update their profile information. Service Providers can search, view own services, add new service, create availability, view all bookings, view member profile, view own profile and reviews. Admins can view/update member profile, view/update service provider profile, view booked services, view payment transaction, transfer amount and view cancellation report.

The aforementioned is a non-limiting discussion of how attributes are deployable and is not meant to restrict or narrow the discussions and embodiments thereof. Not wishing to be bound by theory, the definitions and examples of attributes can be substituted in part, whole, singulars, pluralities, and combinations thereof within the instant discussions as well as the references that are incorporated by reference.

### Attribute Examples and Definitions

Attributes are further definable, as non-limiting examples, as at least one or more property, material, ingredient, amount, machine, intermediary, process, code, label, name, number, state, plus code, postal address, status, article, method, step, component, and combinations thereof from the following references incorporated by Reference.

Attributes can also be or include, as non-limiting examples, at least one or more noun, verb, adjective, adverb, phrase, symbol, mark, nominalized form, indicia, trade name, trademark, wordmark, and combinations thereof from the following references incorporated by Reference.

Attributes can also be or include, as non-limiting examples, at least one prompt, question, poll, question-and-answer, opinion, belief, fact, response, statement, and combinations thereof.

Attributes can also be or include, as non-limiting examples, at least one image, video, stream, pixel, interactive graphic, graphical user interface, and combinations thereof. A stream can be a video stream, electron stream, electronic stream, electricity stream, water stream, utility, fluid, liquid, gas, and the like. Attributes can also be or include, as non-limiting examples, at least one sensible input as audio, visual, color, olfactory, tactile, touch, taste, and combinations thereof.

Attributes can also be or include, as non-limiting examples, at least one or more person, entity, group, program, processor, function, record, action, script, and combinations thereof from the following references incorporated by Reference. Attributes can also include, as a non-limiting list, at least one internet assigned number, ASN, internet protocol address, IP4, IP6, media access control address, resource locator, device number, domain name, URL, address from the internet, AF_INET, alphanumeric serial identifier, hash, host, identification number, identifier, pixel, port, PF_INET, serial number, socket, model number, bit code, blockchain address, blockchain code, wallet, token, NFT, genera thereof, derivatives thereof, sequences thereof, streams thereof, portions thereof, and combinations thereof. These can be addresses of their own and used with attribute addresses by link, reference, hash, encryption, byte, bit, pointer, quanta, and the like.

Attributes referring in any direct or indirect way to one or more persons is a biometric. Attributes may further comprise at least one of analytic, biomarker, fingerprint, food, dental, drug, genetic, genomic, medical, nutrition, insurance, indicator, procedure, retinal pattern, signature, molecular signature, constituent thereof, ingredient thereof, portion thereof, and combinations thereof from the following references incorporated by Reference.

Without being bound by theory, each attribute may have additional attributes according to affiliations, associations, differentia, responses, or statistics. An attribute may be one or more of a category, genus, species, series, order, type, taxonomy, hierarchy, node, leaf, tree, graph, and combinations thereof. Distinctions between attributes may be determinable using genus-species differentiations. Distinctions may further be determined as explained in “Genus, Species and Ordered Series in Aristotle” by A. C. Lloyd in Phronesis, 1962, Vol. 7, No. 1 (1962), pp. 67-90, which is incorporated by Reference.

Examples of attributes are included below, as non-limiting types, at least one or more of: Affects, Agriculture, Finance, Food, Biometrics, Buildings, Census, Classification Systems, Economic Indicators, Energy, Federal Codes, Health, Insurance, Medical, Materials, Nutrition, Opinion, Products, Taxes, Revenue, Expenses, Telephone Numbers, Trademarks, Zip Codes, and combinations thereoffrom the following references incorporated by Reference.

One or more attributes can be determined from the foregoing and one or more of the following references that are each Incorporated by Reference. The entirety of incorporated by reference includes all files and folders that are named, referenced, stated, linked, listed, otherwise referred to in any form or format, and combinations thereof within the directory, directories, subdirectories, and each and every additional subdirectories are recursively incorporated by reference in their entirety or entireties.

### AFFECTS

Angela Ackerman and Becca Puglisi, The Emotion Thesaurus, ePub, 2012, 2018.
emojis, https://unicode.org/emoji/charts/full-emoji-list.html, incorporated herein by reference in entirety.
Charles Darwin, The Expression of the Emotions in Man and Animals, New York: Oxford University Press, 2009, incorporated herein by reference in entirety.
John Koenig. Dictionary of Obscure Feelings. Simon & Schuster, 2021. ISBN-10 1501153641. Incorporated by Reference.
Max Scheler. “An a priori Hierarchy of Value-Modalities,” in Readings in Existential Phenomenology, Daniel O'Connor (tr.), Nathaniel Lawrence and Daniel O'Connor (eds.).
Englewood, N.J.: Prentice Hall, 1967, incorporated herein by reference in entirety.
Max Scheler. Formalism in Ethics and Non-Formal Ethics of Values, 1973, Manfred S. Frings and Roger L. Funk (trs.), Evanston, Ill.: Northwestern University Press, incorporated herein by reference in entirety.
Max Scheler. “Toward a Stratification of the Emotional Life,” in Readings in Existential Phenomenology, Daniel O'Connor (tr.), Nathaniel Lawrence and Daniel O'Connor (eds.).
Englewood, N.J.: Prentice Hall, 1967, incorporated herein by reference in entirety.

### Agriculture and Food

Census of Agriculture, 2017. USDA. Including and not limited to: Full Report, all series, special studies, reports, and profiles. https://www.nass.usda.gov/Publications/AgCensus/2017/index.php. Example digital files included. Incorporated by Reference.
Food Data Central. USDA. https://fdc.nal.usda.gov/. Example digital files included.

### INCORPORATED BY REFERENCE

### Buildings

AHRI Certifications. https://www.ahrinet.org/certification/ahri-certification-programs. Example digital files included. Incorporated by Reference.
ASHRAE Handbook—Fundamentals, 2021. Incorporated by Reference.
ASHRAE Handbook—HVAC Systems & Equipment, 2020. Incorporated by Reference.
ASHRAE Handbook—HVAC Applications, 2019. Incorporated by Reference.
ASHRAE Handbook—Refrigeration, 2018. Incorporated by Reference.
Department of Energy. Including and not limited to: Better Buildings, Superior Energy Performance, Energy Star, Energy Star Homes, Portfolio Manager, checklists, toolkits, tools, and worksheets. Applying Energy Data Tools to Inform the Valuation of Commercial Buildings. Cost Effectiveness Screening Tool, and Decarbonizing HVAC and Water Heating in Commercial Buildings. Searchable Databases. https://betterbuildingssolutioncenter.energy.gov/solutions, https://www.energystar.gov/products/spec,
https://www.energystar.gov/productfinder/,
https://www.energystar.gov/products/buildig_products/residentialng_windows_doors_and_skylights/key_product_criteria,
https://portfoliomanager.energystar.gov/pm/dataCollectionWorksheet,
https://www.energystar.gov/industrialplants/earn-recognition/plant-certification/how-to-apply,
https://basc.pnnl.gov/home-improvement-expert/checklists. Example digital files included. Incorporated by Reference. Results of Searchable Databases incorporated by Reference.
Energy Star Residential. https://www.energystar.gov/partner_resources/residential_new. Example digital files included. Incorporated by Reference.
Firth, et al. “Targeting household energy-efficiency measures using sensitivity analysis.” Building Research & Information (2010) 38(1), 25-41. Incorporated by Reference.
Lawrence, T Darwich, A. R., & Means, J. K. (2018). ASHRAE GreenGuide: Design, Construction, and Operation of Sustainable Buildings: Vol, Fifth edition. ASHRAE. Incorporated by Reference.

### Census

US Census Questionnaire https://www.census.gov/programs-surveys/decennial-census/technical-documentation/questionnaires.2020_Census. Example digital files included. Incorporated by Reference.

### Classification Systems

Harmonized Tariff Schedule, https://hts.usitc.gov/current. Example digital files included. Incorporated by Reference.
North American Industrial Classification System, https://www.census.gov/naics/reference_files_tools/2017_NAICS_Manual.pdf. Example digital files included. Incorporated by Reference.
Product and Service Code Manual. https://www.acquisition.gov/psc-manual. Example digital files included. Incorporated by Reference.
Standard Industrial Classification (SIC) Code Description. https://www.census.gov/programs-surveys/cbp/technical-documentation/reference/naics-descriptions/sic-code-descriptions.html. Example digital files included. Incorporated by Reference.

### Economic Indicators

Bureau of Economic Analysis. Including and not limited to: Methodologies, BEA Data, Gross Domestic Product (GDP), Consumer Spending, Income & Saving, Industries, International Trade & Investment, Prices & Inflation, Investment in Fixed Assets, Employment, Government, Special Topics, United States United States & the World States and Territories County, Metro, Other Local Areas, National, Regional, Industry, and International. https://www.bea.gov/data, https://www.bea.gov/tools, and https://www.bea.gov/resources/methodologies. Example digital files included. Incorporated by Reference.
Bureau of Labor Statistics. Including and not limited to: Inflation & Prices, Pay & Benefits, Spending & Time Use, Employment, Unemployment, Workplace Injuries, Occupational Requirements, Productivity, and National Longitudinal Surveys. https://www.bls.gov/, https://www.bls.gov/bls/sitemap.htm, https://www.nlsinfo.org/, and https://www.nlsinfo.org/sitemap. Example digital files included. Incorporated by Reference.

### Energy

U.S. Energy Information Administration. Markets & Finance, Environment, Reports. https://www.eia.gov/environment/reports.php. Searchable Databases. Example digital files included: Incorporated by Reference. Results of Searchable Databases incorporated by Reference.

### Federal Codes

Code of Federal Regulations. U.S. General Services Administration, National Archives and Records Service, Office of the Federal Register, Titles 1-50. U.S. Government Printing Office, and https://www.ecfr.gov/. Incorporated by Reference.

### Health and Nutrition/Biometrics

Centers for Disease Control and Prevention. Including and not limited to: Division of Nutrition, Physical Activity, and Obesity, https://www.cdc.gov/nccdphp/dnpao/division-information/data-stats/index.htm; Health United States, https://www.cdc.gov/nchs/data/hus/hus19-508.pdf; and Micronutrient Factsheet, https://www.cdc.gov/nutrition/about-micronutrients/index.html. Example digital files included. Incorporated by Reference.
Dietary Supplement Ingredient Database. https://dietarysupplementdatabase.usda.nih.gov/. Searchable Database. Example digital files included. Incorporated by Reference. Results of Searchable Databases Incorporated by Reference.
National Health and Nutrition Examination Survey. https://www.cdc.gov/nchs/nhanes/index.htm. Example digital files included. Incorporated by Reference.
National Institutes of Health, Dietary Supplements Fact Sheets, https://ods.od.nih.gov/factsheets/list-all/. Example digital files included. Incorporated by Reference.
National Report on Biochemical Indicators of Diet and Nutrition in the U.S. Population, https://www.cdc.gov/nutritionreport/index.html. Example digital files included. Incorporated by Reference.
What We Eat in America, National Health and Nutrition Examination Survey. https://www.ars.usda.gov/nea/bhnrc/fsrg. Example digital files included. Incorporated by Reference.

### Insurance

Uniform Property and Casualty Codes. https://www.naic.org/documents/industry_pcm_p_c_2020.pdf. Example digital files included. Incorporated by Reference
X12 Codes. https://x12.org/codes. Example digital files included. Incorporated by Reference.

### Medical/Biometrics

American Dental Association. Code on Denial Procedures. 2022. https://www.ada.org/publications/cdt. Example digital files included. Incorporated by Reference.
American Medical Association. (2022). Current Procedural Terminology: CPT: 2015: Vol. Professional edition. American Medical Association.
Centers for Medicare and Medicaid Services. https://www.cms.gov/medicare-coverage-database/search.aspx. Including and not limited to: Medicare Coverage Database, Local Coverage Determinations, and National Coverage Determinations. Searchable Database. Example digital files included. Incorporated by Reference. Results of Searchable Databases Incorporated by Reference.
Encyclopedia of Behavioral Neuroscience. Richard F. Thompson. Volume 1. A-G, Volume 2. H-O, Volume 3. P-V & index. Published in London; Burlington, Mass.: Academic Press, c2010. Incorporated by Reference.
Food and Drug Administration. https://dailymed.nlm.nih.gov/dailymed/spl-resources-all-drug-labels.cfm. https://www.fda.gov/industry/structured-product-labeling-resources/nsde. https://www.fda.gov/drugs/science-and-research-drugs/table-pharmacogenomic-biomarkers-drug-labeling. Including and not limited to: Human Prescription Labels, Human Over The Counter Labels, Homeopathic Labels, Animal Labels, Remainder Labels, Comprehensive National Drug Code Structure Product Labeling Data Elements File, and Pharmacogenomic Biomarkers in Drug Labeling. Example digital files included. Incorporated by Reference.
Health Care Provider Taxonomy Code Set. https://www.nucc.org/index.php/code-sets-mainmenu-41/provider-taxonomy-mainmenu-40/pdf-mainmenu-53. Example digital files included. Incorporated by Reference.
National Drug Code Directory. https://www.fda.gov/drugs/drug-approvs-and-databases/national-drug-code-directory. Including and not limited to: National Drug Code Directory Packages, National Drug Code Directory Products, National Drug Code Directory Excluded Packages, and National Drug Code Directory Excluded Products, Example digital files included. Incorporated by Reference.
National Institutes of Health, Genbank, genetic sequences, all databases. Searchable Database. https://www.ncbi.nlm.nih.gov/genbank/. Incorporated by Reference. Results of Searchable Databases Incorporated by Reference.

### Opinion

Gallup Topics and Trends. https://news.gallup.com/poll/trends.aspx. Example digital files included. Incorporated by Reference.
Health Poll Database. https://www.healthpolldatabase.org/hpd/. Searchable Database. Example digital files included. Incorporated by Reference. Results of Searchable Databases incorporated by Reference.
Nielsen Consumer Survey. Booklet, e-Booklet, Telephone Survey, TV Diary. https://www.nielsensurvey.com/, https://scarboroughlocal.nielsen.com/nielsen-local-surveys/completing-survey.html, and https://scarboroughlocal.nielsen.com/nielsen-local-surveys/index.html. Incorporated by Reference.
Pew Research Center. Tools & Resources. https://www.pewresearch.org/tools-and-resources/. Example digital files included. Incorporated by Reference.
Polling America: an encyclopedia of public opinion/edited by Samuel J. Best and Benjamin Radcliff. Published in Westport, Conn.: Greenwood Press, 2005. Volume 1 and Volume 2.
Roper iPoll. Searchable database. https://ropercenter.cornell.edu/ipoll/. Example digital files included. Incorporated by Reference. Results of Searchable Databases Incorporated by Reference.

### Products and Materials

Consumer Product Information Database. Searchable Database. https://www.whatsinproducts.com/chemicals/index/1. Example digital files included. Incorporated by Reference. Results of Searchable Databases incorporated by Reference.
Encyclopedia of materials: science and technology/editors in chief, by K. H. Jurgen Buschow, et al. Published Amsterdam; New York: Elsevier, 2001. Including and not limited to: Volumes 1, 2, 3, 4, 5, 6, 7, 8, 9, 10, and 11. Incorporated by Reference.
Encyclopedia of materials: science and technology/editors in chief, by K. H. Jurgen Buschow, et al. Published Amsterdam; New York: Elsevier, 2001. Volumes 1-11. Electronic resources. https://www.sciencedirect.com/book/9780080431529/encyclopedia-of-materials-science-and-technology. Example digital files included. Incorporated by Reference.
Encyclopedia of materials science research. Batukhan B. Chinbat and Sora H. Mori, editors. Published New York: NOVA/Nova Science Publishers c2012. Incorporated by Reference.

### Taxes, Revenues, and Expenses

Internal Revenue Service Forms and Publications. https://apps.irs.gov/app/picklist/list/formsPublications.html. Example digital files included. Incorporated by Reference.

### Telephone Codes

Telephone Numbering Data. https://www.fcc.gov/general/telephone-numbering-data. Example digital files included. Incorporated by Reference.

### Trademarks

Trademark Electronic Search System (TESS). Searchable Database. http://tess2.uspto.gov/. Incorporated by Reference. Results of Searchable Databases Incorporated by Reference.
Trademark Gazette. http://tmog.uspto.gov/, https://eog-tmng.uspto.gov/, and https://www.uspto.gov/learning-and-resources/official-gazette/trademarks/trademark-official-gazette-tmog-archived-editions. Searchable Database. Example digital files included. Incorporated by Reference. Results of Searchable Databases Incorporated by Reference.

### ZIP Codes

Look Up A ZIP Code. Searchable Database. https://tools.usps.com/zip-code-lookup.htm. Incorporated by Reference Results of Searchable Databases Incorporated by Reference.
ZIP Codes. Tables of Zip Codes for cities and states. Example digital files included. Incorporated by Reference.
ZIP Code Prefixes. https://pe.usps.com/Archive/HTML/DMMArchive20050106/print/L002.htm. Example digital files included. Incorporated by Reference.

What is claimed is:

1. A method of transmitting data, comprising:
requesting, at a first digital device of a user, content for display from a second digital device;
receiving attribute data about the content, wherein the content is at least one media, text, image, audio, video, price, or combinations thereof;
modifying the attribute data based on one or more attributes;
receiving, at the first digital device, a digital record from a third digital device, wherein the first, second, and third devices have different device addresses, wherein the digital record is retrievable using the one or more attributes about the user, and wherein the digital record is stored in a memory device in a third digital device;
rendering the display of the content using the digital record to modify one or more attributes of the content based on the user attributes; and
sending data about the modification to the third digital device.

2. The method of claim 1, wherein the one or more attributes correspond with a characteristic of a product, service, person, or entity.

3. The method of claim 1, wherein the digital record further comprises programmable media that can store data, which is accessible and readable by a third digital device.

4. The method of claim 1, wherein the digital record is accessed using a clearinghouse that links a record and attribute with at least a third digital device.

5. The method of claim 1, wherein the digital record is accessible on a network using at least one IP address, MAC address, or device identifier.

6. The method of claim 1, wherein the digital record can store an amount associated with an account, currency, reward, balance, points, money, crypto, and combinations thereof.

7. A method of using an attribute address, comprising:
receiving, at a first device, access to data comprising categories, instances, and attributes;
determining one or more attributes of instances that correspond with interests of users;
generating one or more alphanumerical representations for each attribute;
selecting one or more attributes based on the interests of the user;
generating at least one address using the alphanumerical representations;
registering the address and interests of a user in a second electronic device; and
receiving at the second electronic device, from a third electronic device, at least one digital record using one or more attributes addressed to a user at a fourth device.

8. The method of claim 7, further comprising generating an electronic address that can be used to transmit data from one server to another based on one or more attributes.

9. The method of claim 7, wherein the digital record links to an electronic record within a memory storage device that can perform an operation.

10. The method of claim 7, wherein determining attributes further comprises identifying one or more attributes of a set of species and determining whether a subset has one or more similar attributes.

11. The method of claim 7, wherein the step of addressing associates at least one attribute of the instance to an account or device.

12. The method of claim 7, wherein the digital record can store one or more of an amount, balance, ad, media, text, image, audio, video, price, or combinations thereof.

13. The method of claim 7, wherein the one or more attributes are determined according to one or more affects, agriculture, finance, food, biometric, building, census, classification systems, economic indicators, energy, federal codes, health, insurance, medical, materials, nutrition, opinion, products, taxes, revenue, expenses, telephone numbers, trademarks, zip codes, device address, and combinations thereof.

14. A method of optimizing carbon-dioxide equivalent emissions comprising:
receiving a make and model number of equipment;
determining at least one energy load of the equipment;
storing energy load information;
determining one or more energy sources;
determining interval data; and
using a machine learning technique to determine performance optimization for the equipment, wherein the method is performed without the use of peripheral sensors.

15. The method of claim 14, wherein the equipment is an air conditioner, appliance, condenser, furnace, water heater, electronic device, television, automobile, energy device, or combinations thereof.

16. The method of claim 14, wherein a user inputs data in the form of turning off a machine, raising a temperature, lowering a temperature, starting a cycle, or combinations thereof.

17. The method of claim 14, further comprising selectively controlling, by a control, the interval data in the form of turning off a machine, turning off a machine, raising a temperature, lowering a temperature, starting a cycle, and combinations thereof.

18. The method of claim 14, wherein the user provides at least one account associated with a utility, cart, credit card, bank, grocery, payment, reward, wallet, and combinations thereof.

19. The method of claim 18, further comprising debiting or crediting an account by another entity, person, or program.

20. The method of claim 14, further comprising determining a delta between an optimized level and a before-optimized level for producing a credit.
